(19) United States
(12) Patent Application Publication
(10) Pub. No.: US 2025/0167965 A1
(43) Pub. Date: May 22, 2025

(54) FREQUENCY DOMAIN (FD)-SCRAMBLED FREQUENCY MODULATED CONTINUOUS WAVE (FMCW) SIGNALING

(71) Applicant: QUALCOMM Incorporated, San Diego, CA (US)

(72) Inventors: Kangqi LIU, San Diego, CA (US); Weimin DUAN, San Diego, CA (US); Jing JIANG, San Diego, CA (US)

(21) Appl. No.: 18/511,961

(22) Filed: Nov. 16, 2023

(51) Int. Cl. H04L 5/00; H04L 25/02

(52) U.S. Cl. CPC H04L 5/0062; H04L 5/005; H04L 25/0226

(57) ABSTRACT

Methods, systems, and devices for wireless communications are described. The described techniques provide for a device to distinguish between signals transmitted using frequency modulated continuous wave (FMCW) waveforms. A first wireless device may apply a frequency-domain (FD) scrambling sequence to a reference signal for transmission, and a second wireless device may receive at least a portion of the signal and de-scramble the signal using the FD scrambling sequence. In some examples, the first wireless device may transmit configuration signaling indicating the FD scrambling sequence corresponding to the first wireless device. Additionally, or alternatively, the first wireless device may transmit an indication for the second wireless device to determine the FD scrambling sequence based on identifier (ID) information (e.g., an ID associated with the first wireless device). In some examples, the first wireless device, the second wireless device, or both may use analog or digital transceivers.

### FIELD OF TECHNOLOGY

The following relates to wireless communications, including frequency domain (FD)-scrambled frequency modulated continuous wave (FMCW) signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communication devices in a wireless communications system may use frequency modulated continuous wave (FMCW) signaling for sensing, communications, or other purposes. In some cases, the coexistence of multiple devices or radars transmitting within the wireless communications system may potentially interfere with the FMCW signaling, reducing a detection capability, communication reliability, or both for the FMCW signaling.

### SUMMARY

The described techniques relate to improved methods, systems, devices, and apparatuses that support frequency domain (FD)-scrambled frequency modulated continuous wave (FMCW) signaling. For example, the described techniques provide for a first wireless device to generate an FD representation of a reference signal based on a discrete Fourier transform (DFT) of an FMCW and scramble the FD representation of the reference signal using an FD scrambling sequence. The first wireless device may transmit a wideband signal for channel estimation of a channel based on the scrambled FD representation of the reference signal. In some examples, the first wireless device may transmit configuration signaling indicating the FD scrambling sequence associated with the first wireless device. A second wireless device receiving the configuration signaling may use the indicated FD scrambling sequence for de-scrambling reference signals received from the first wireless device. Additionally, or alternatively, the first wireless device may transmit an indication for the second wireless device to determine the FD scrambling sequence based on identifier information (e.g., a cell identifier, a user equipment (UE) identifier, or both associated with the first wireless device).

The second wireless device may receive at least a portion of the wideband signal. The second wireless device may de-scramble at least the portion of the wideband signal based on the FD scrambling sequence corresponding to the first wireless device. The second wireless device may communicate signaling with the first wireless device via a channel according to channel estimation based on the de-scrambled portion of the wideband signal. In some examples, the second wireless device may determine an identifier of the first wireless device associated with the wideband signal based on de-scrambling the portion of the wideband signal. For example, if the second wireless device successfully de-scrambles the portion of the wideband signal using the FD scrambling sequence corresponding to the first wireless, the second wireless device may determine that the wideband signal was transmitted by the first wireless device. In some examples, the second wireless device may perform interference cancelation of other signaling (e.g., other FMCW signals) associated with one or more other wireless devices based on determining the identifier of the first wireless device.

A method for wireless communications by a first wireless device is described. The method may include generating an FD representation of a reference signal based on a DFT of an FMCW, scrambling the FD representation of the reference signal using an FD scrambling sequence corresponding to the first wireless device, and transmitting a wideband signal for channel estimation of a channel at a second wireless device based on the scrambled FD representation of the reference signal.

A first wireless device for wireless communications is described. The first wireless device may include one or more memories storing processor-executable code, and one or more processors of the first wireless device (e.g., a UE or a network entity) coupled with the one or more memories. The one or more processors may be individually or collectively operable to execute the code to cause the first wireless device to generate an FD representation of a reference signal based on a DFT of an FMCW, scramble the FD representation of the reference signal using an FD scrambling sequence corresponding to the first wireless device, and transmit a wideband signal for channel estimation of a channel at a second wireless device based on the scrambled FD representation of the reference signal.

An apparatus at a first wireless device for wireless communications is described. The apparatus may include means for generating an FD representation of a reference signal based on a DFT of an FMCW, means for scrambling the FD representation of the reference signal using an FD scrambling sequence corresponding to the first wireless device, and means for transmitting a wideband signal for channel estimation of a channel at a second wireless device based on the scrambled FD representation of the reference signal.

A non-transitory computer-readable medium storing code for wireless communications is described. The code may include instructions executable by one or more processors to generate an FD representation of a reference signal based on a DFT of an FMCW, scramble the FD representation of the reference signal using an FD scrambling sequence corresponding to the first wireless device, and transmit a wideband signal for channel estimation of a channel at a second wireless device based on the scrambled FD representation of the reference signal.

Some examples of the method, first wireless device, apparatus, and non-transitory computer-readable medium described herein may further include operations, features, means, or instructions for communicating signaling via the channel according to the channel estimation of the channel based on the scrambled FD representation of the reference signal.

Some examples of the method, first wireless device, apparatus, and non-transitory computer-readable medium described herein may further include operations, features, means, or instructions for transmitting configuration signaling indicating the FD scrambling sequence corresponding to the first wireless device. In some examples of the method, first wireless device, apparatus, and non-transitory computer-readable medium described herein, the configuration signaling includes a radio resource control (RRC) signal, a medium access control (MAC)-control element (CE) signal, a downlink control information (DCI) signal, or any combination thereof.

Some examples of the method, first wireless device, apparatus, and non-transitory computer-readable medium described herein may further include operations, features, means, or instructions for transmitting an indication to determine the FD scrambling sequence based on a cell identifier (ID) associated with the first wireless device, a UE ID associated with the first wireless device, or any combination thereof.

In some examples of the method, first wireless device, apparatus, and non-transitory computer-readable medium described herein, a length of the FD scrambling sequence may be based on a capability of the second wireless device. In some examples of the method, first wireless device, apparatus, and non-transitory computer-readable medium described herein, the capability of the second wireless device may be based on a baseband bandwidth processing capability, an analog receiving capability, a digital receiving capability, or any combination thereof of the second wireless device.

In some examples of the method, first wireless device, apparatus, and non-transitory computer-readable medium described herein, scrambling the FD representation of the reference signal may include operations, features, means, or instructions for scrambling a set of multiple sets of contiguous frequency resources of the FD representation of the reference signal based on a length of the FD scrambling sequence, where a set of contiguous frequency resources within the set of multiple sets of contiguous frequency resources may be scrambled using a respective bit of the FD scrambling sequence.

In some examples of the method, first wireless device, apparatus, and non-transitory computer-readable medium described herein, transmitting the wideband signal may include operations, features, means, or instructions for transmitting the wideband signal via a digital transceiver or an analog transceiver.

Some examples of the method, first wireless device, apparatus, and non-transitory computer-readable medium described herein may further include operations, features, means, or instructions for determining the FD scrambling sequence based on a digital modulation scheme of the first wireless device, a cell ID associated with the first wireless device, a UE ID associated with the first wireless device, or any combination thereof.

A method for wireless communications by a second wireless device is described. The method may include receiving at least a portion of a wideband signal for channel estimation of a channel, the wideband signal associated with a first wireless device and based on an FMCW, de-scrambling the portion of the wideband signal using an FD scrambling sequence corresponding to the first wireless device, and communicating signaling via the channel according to the channel estimation of the channel based on the de-scrambled portion of the wideband signal.

A second wireless device for wireless communications is described. The second wireless device may include one or more memories storing processor-executable code, and one or more processors of the second wireless device (e.g., a UE or a network entity) coupled with the one or more memories. The one or more processors may be individually or collectively operable to execute the code to cause the second wireless device to receive at least a portion of a wideband signal for channel estimation of a channel, the wideband signal associated with a first wireless device and based on an FMCW, de-scramble the portion of the wideband signal using an FD scrambling sequence corresponding to the first wireless device, and communicate signaling via the channel according to the channel estimation of the channel based on the de-scrambled portion of the wideband signal.

An apparatus of a second wireless device for wireless communications is described. The apparatus may include means for receiving at least a portion of a wideband signal for channel estimation of a channel, the wideband signal associated with a first wireless device and based on an FMCW, means for de-scrambling the portion of the wideband signal using an FD scrambling sequence corresponding to the first wireless device, and means for communicating signaling via the channel according to the channel estimation of the channel based on the de-scrambled portion of the wideband signal.

A non-transitory computer-readable medium storing code for wireless communications is described. The code may include instructions executable by one or more processors to receive at least a portion of a wideband signal for channel estimation of a channel, the wideband signal associated with a first wireless device and based on an FMCW, de-scramble the portion of the wideband signal using an FD scrambling sequence corresponding to the first wireless device, and communicate signaling via the channel according to the channel estimation of the channel based on the de-scrambled portion of the wideband signal.

Some examples of the method, second wireless device, apparatus, and non-transitory computer-readable medium described herein may further include operations, features, means, or instructions for determining an ID of the first wireless device associated with the wideband signal based on de-scrambling the portion of the wideband signal using the FD scrambling sequence. Some examples of the method, second wireless device, apparatus, and non-transitory computer-readable medium described herein may further include operations, features, means, or instructions for performing interference cancelation of additional signaling associated with a third wireless device based on the ID of the first wireless device associated with the wideband signal.

Some examples of the method, second wireless device, apparatus, and non-transitory computer-readable medium described herein may further include operations, features, means, or instructions for receiving configuration signaling indicating the FD scrambling sequence. In some examples of the method, second wireless device, apparatus, and non-transitory computer-readable medium described herein, the configuration signaling includes an RRC signal, a MAC-CE signal, a DCI signal, or any combination thereof.

Some examples of the method, second wireless device, apparatus, and non-transitory computer-readable medium described herein may further include operations, features, means, or instructions for receiving an indication to determine the FD scrambling sequence based on a cell ID associated with the first wireless device, a UE ID associated with the first wireless device, or any combination thereof and determining the FD scrambling sequence based on the indication.

In some examples of the method, second wireless device, apparatus, and non-transitory computer-readable medium described herein, a length of the FD scrambling sequence may be based on a capability of the second wireless device. In some examples of the method, second wireless device, apparatus, and non-transitory computer-readable medium described herein, the capability of the second wireless device may be based on a baseband bandwidth processing capability, an analog receiving capability, a digital receiving capability, or any combination thereof of the second wireless device.

In some examples of the method, second wireless device, apparatus, and non-transitory computer-readable medium described herein, de-scrambling the portion of the wideband signal may include operations, features, means, or instructions for de-scrambling a set of multiple sets of contiguous frequency resources corresponding to the portion of the wideband signal based on a length of the FD scrambling sequence, where a set of contiguous frequency resources within the set of multiple sets of contiguous frequency resources may be de-scrambled using a respective bit of the FD scrambling sequence.

In some examples of the method, second wireless device, apparatus, and non-transitory computer-readable medium described herein, receiving at least the portion of the wideband signal may include operations, features, means, or instructions for receiving at least the portion of the wideband signal via a digital transceiver or an analog transceiver.

In some examples of the method, second wireless device, apparatus, and non-transitory computer-readable medium described herein, de-scrambling the portion of the wideband signal may include operations, features, means, or instructions for generating a local FMCW and de-scrambling the portion of the wideband signal based on combining the local FMCW with the FMCW corresponding to the wideband signal.

### BRIEF DESCRIPTION OF THE DRAWINGS

FIGS. 1 and 2 show examples of wireless communications systems that support frequency domain (FD)-scrambled frequency modulated continuous wave (FMCW) signaling in accordance with one or more aspects of the present disclosure.

FIG. 3 shows an example of transmitter and receiver processes that support FD-scrambled FMCW signaling in accordance with one or more aspects of the present disclosure.

FIG. 4 shows an example of a process flow that supports FD-scrambled FMCW signaling in accordance with one or more aspects of the present disclosure.

FIGS. 5 and 6 show block diagrams of devices that support FD-scrambled FMCW signaling in accordance with one or more aspects of the present disclosure.

FIG. 7 shows a block diagram of a communications manager that supports FD-scrambled FMCW signaling in accordance with one or more aspects of the present disclosure.

FIG. 8 shows a diagram of a system including a UE that supports FD-scrambled FMCW signaling in accordance with one or more aspects of the present disclosure.

FIG. 9 shows a diagram of a system including a network entity that supports FD-scrambled FMCW signaling in accordance with one or more aspects of the present disclosure.

FIGS. 10 through 13 show flowcharts illustrating methods that support FD-scrambled FMCW signaling in accordance with one or more aspects of the present disclosure.

### DETAILED DESCRIPTION

Some wireless communications systems (e.g., 5G or 5G+ systems) may provide increased bandwidth allocations for wireless devices. Some such wireless communications systems may support joint communication or radio frequency sensing (JCS) to improve communications, sensing, or both for the wireless devices. In some examples, wireless devices may use frequency modulated continuous waves (FMCWs) or waveforms for one or more purposes (e.g., sensing, positioning, communications, JCS). However, in some wireless communications systems, the coexistence of multiple wireless devices transmitting FMCWs in congested traffic (e.g., based on an increasing quantity of radar-equipped vehicles transmitting FMCW signals for sensing, communications, or both) may negatively affect communications. For example, interference caused by other wireless devices transmitting FMCWs may affect the sensing functionality of a wireless device receiving one or more FMCW signals, such that a detection capability of the wireless device receiving the one or more FMCW signals may decrease. To enhance the sensing functionality and communication reliability of such a wireless device, a wireless communications system may support an improved mechanism for distinguishing between transmitted FMCW signals.

The wireless communications system may support frequency-domain (FD) scrambling sequences for distinguishing between FMCWs. For example, a first wireless device transmitting an FMCW signal (e.g., a “transmitting device”) may apply an FD scrambling sequence specific to the transmitting device to an FMCW signal prior to transmission of the FMCW signal. A second wireless device receiving the FMCW signal (e.g., a “receiving device”) may receive the FMCW signal and may de-scramble the signal using the FD scrambling sequence specific to the transmitting device. Based on the receiving device successfully de-scrambling the FMCW signal using the FD scrambling sequence specific to the transmitting device, the receiving device may determine that the FMCW signal was transmitted by the transmitting device, effectively differentiating the FMCW signal from other FMCW signals received or otherwise detected at the receiving device. In some examples, the transmitting device may transmit configuration signaling indicating the FD scrambling sequence specific to the transmitting device. Additionally, or alternatively, the transmitting device may transmit an indication for the receiving device to use a cell identifier (ID), a UE ID, or some combination of these or other identifying information to determine the FD scrambling sequence specific to the transmitting device. In some examples, the transmitting device, the receiving device, or both may use analog transceivers. Additionally, or alternatively, the transmitting device, the receiving device, or both may use digital transceivers.

Aspects of the disclosure are initially described in the context of wireless communications systems. Aspects of the disclosure are further illustrated by and described with reference to transmitter processes, receiver processes, and a process flow. Aspects of the disclosure are further illustrated by and described with reference to apparatus diagrams, system diagrams, and flowcharts that relate to FD-scrambled FMCW signaling.

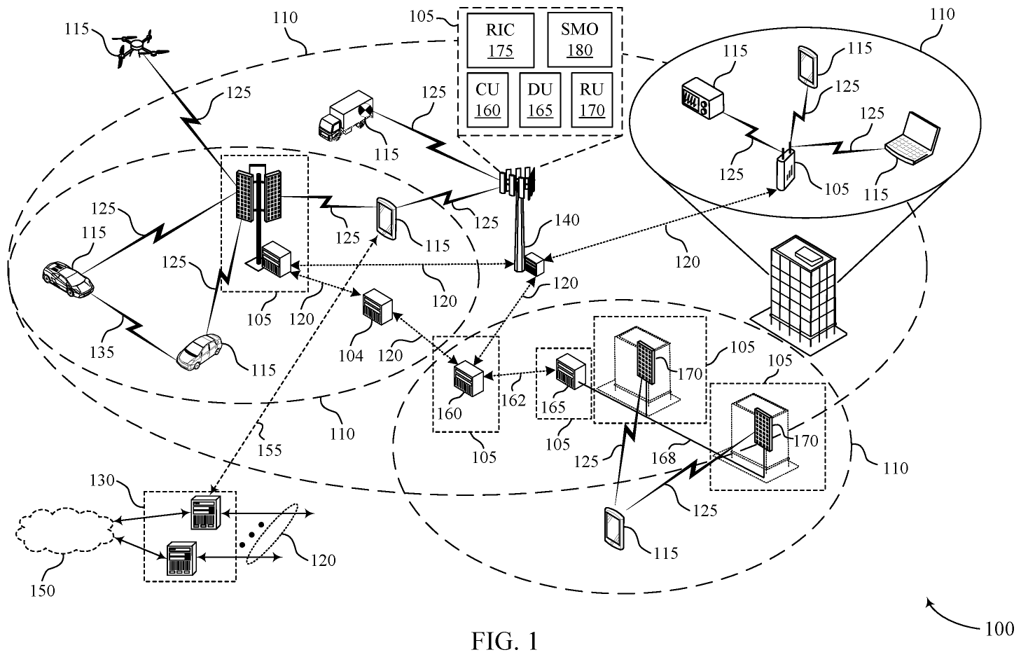

FIG. 1 shows an example of a wireless communications system 100 that supports FD-scrambled FMCW signaling in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support frequency domain (FD)-scrambled frequency modulated continuous wave (FMCW) signaling as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Some wireless communications systems 100 (e.g., 5G or 5G+ systems) may provide increased bandwidth allocations for wireless devices (e.g., UEs 115, network entities 105, or both). Some such wireless communications systems 100 may support JCS to improve communications, sensing, or both for the wireless devices. In some examples, wireless devices may use FMCWs for one or more purposes (e.g., sensing, positioning, communications, JCS). However, in some other wireless communications systems, the coexistence of multiple wireless devices transmitting FMCWs in congested traffic (e.g., based on an increasing quantity of radar-equipped vehicles transmitting FMCW signals for sensing, communications, or both) may negatively affect communications. For example, interference caused by other wireless devices transmitting FMCWs may affect the sensing functionality of a wireless device receiving one or more FMCW signals, such that a detection capability of the wireless device receiving the one or more FMCW signals may decrease. To enhance the sensing functionality and communication reliability of such wireless devices, the wireless communications system 100 may support an improved mechanism for distinguishing between transmitted FMCW signals.

The wireless communications system 100 may support FD scrambling sequences for distinguishing between FMCWs. For example, a first wireless device transmitting an FMCW signal (e.g., a “transmitting device,” which may be an example of a network entity 105 or a UE 115) may apply an FD scrambling sequence specific to the transmitting device to an FMCW signal prior to transmission of the FMCW signal. A second wireless device receiving the FMCW signal (e.g., a “receiving device,” which may be an example of another network entity 105 or UE 115) may receive the FMCW signal and may de-scramble the signal using the FD scrambling sequence specific to the transmitting device. Based on the receiving device successfully de-scrambling the FMCW signal using the FD scrambling sequence specific to the transmitting device, the receiving device may determine that the FMCW signal was transmitted by the transmitting device, effectively differentiating the FMCW signal from other FMCW signals received or otherwise detected by the receiving device. In some examples, the transmitting device may transmit configuration signaling indicating the FD scrambling sequence specific to the transmitting device. Additionally, or alternatively, the transmitting device may transmit an indication for the receiving device to use a cell ID, a UE ID, or some combination of these or other identifying information to determine the FD scrambling sequence specific to the transmitting device. In some examples, the transmitting device, the receiving device, or both may use analog transceivers for FMCW signaling. Additionally, or alternatively, the transmitting device, the receiving device, or both may use digital transceivers for the FMCW signaling.

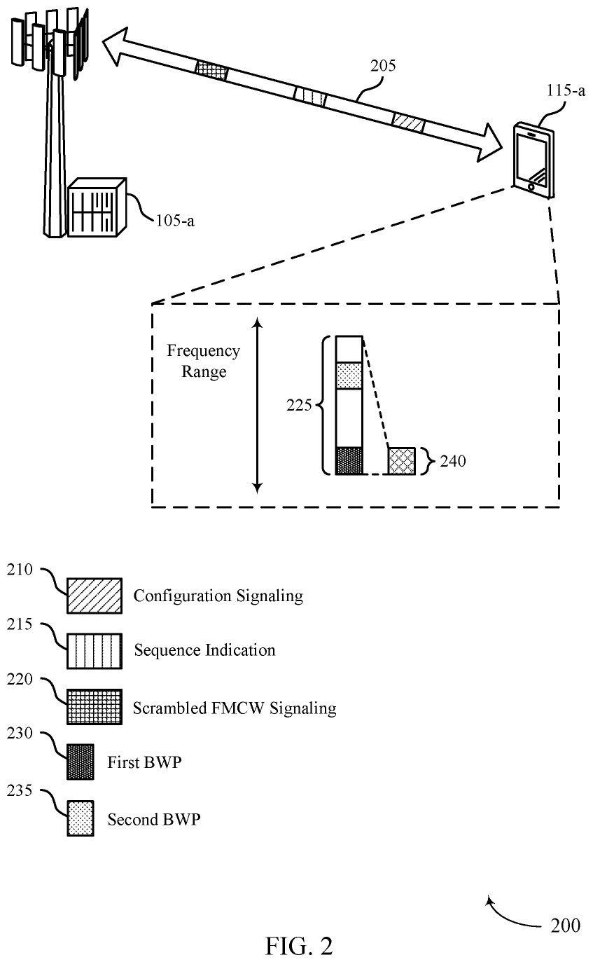

FIG. 2 shows an example of a wireless communications system 200 that supports FD-scrambled FMCW signaling in accordance with one or more aspects of the present disclosure. In some examples, the wireless communications system 200 may implement or be implemented by aspects of the wireless communications system 100. For example, the wireless communications system 200 may include one or more network entities 105 (e.g., a network entity 105-a) and one or more UEs 115 (e.g., a UE 115-a), which may be examples of the corresponding devices described with reference to FIG. 1. In some examples, a first wireless device transmitting a signal, which may be referred to herein as a “transmitting device” or “transmitter device,” and a second wireless device receiving a signal, which may be referred to herein as a “receiving device” or “receiver device,” may communicate scrambled FMCW signaling 220 via a channel 205. The scrambled FMCW signaling 220 may be used to facilitate an estimation of the channel 205 by the receiving device or may indicate communication information. In some examples, the transmitting device may be an example of a network entity 105-a and the receiving device may be an example of a UE 115-a. Additionally, or alternatively, a UE 115 may operate as a transmitting device as described herein, a network entity 105 may operate as a receiving device as described herein, or both. In some examples, the transmitting device, the receiving device, or both may include a transmitter, a receiver, a transceiver, or some combination thereof that perform the signaling described herein.

In some cases, the UE 115-a may estimate (e.g., measure) the channel 205 (e.g., an OFDM channel or other channel) based on one or more received signals to improve reliability and throughput of transmissions and receptions by the UE 115-a. In some examples, the UE 115-a may support a narrowband baseband processing capability 240. The UE 115-a may communicate via the channel 205 using a first bandwidth part (BWP) 230 (e.g., associated with a narrowband bandwidth in accordance with the UE's narrowband baseband processing capability 240), where the first BWP 230 is from a set of BWPs associated with a wideband channel 225. For example, the first BWP 230 may be a subset of a whole channel bandwidth supported by the network entity 105-a.

In some cases, a second BWP 235 associated with the wideband channel 225 (e.g., within the channel bandwidth) may be allocated for other purposes (e.g., for spectrum allocation or multiplexing for multiple wireless devices). In some such cases, the UE 115-a may measure the channel 205 (e.g., perform a channel estimation procedure) using one or more signals to estimate channel metrics for the wideband channel 225 (e.g., to determine channel metrics for both the first BWP 230 and the second BWP 235, to determine a preferred sub-band within the channel bandwidth).

In some other systems, a UE receiving signaling via the first BWP 230 may be unable to measure the channel 205 for the second BWP 235 due to an inability to receive one or more signals via the second BWP 235. For example, the UE may fail to estimate the channel 205 over the entire channel bandwidth for the wideband channel 225. In some other cases, such a UE may implement frequency hopping to estimate the channel 205 for the second BWP 235, receiving signaling via the first BWP 230 to estimate the channel for the first BWP 230 and hopping to receive the signaling via the second BWP 235 to estimate the channel for the second BWP 235. In some examples, the channel 205 via the first BWP 230 may be associated with relatively lower channel quality metrics than the channel via the second BWP 235. However, the UE may be unaware that the channel 205 via the second BWP 235 is associated with a relatively higher channel quality due to the UE's inability to measure the channel 205 via the second BWP 235 or due to a delay associated with measuring the channel 205 via the second BWP 235 due to frequency hopping. In some cases, such a UE may continue to communicate via the first BWP 230 instead of the second BWP 235, which may potentially result in reduced communication performance.

The wireless communications system 200 may support an FMCW-based channel estimation, such that the UE 115-a may perform channel estimation for the wideband channel 225 using narrowband baseband signaling (e.g., via the first BWP 230), for example, based on the narrowband baseband processing capability 240 of the UE 115-a. The UE 115-a may select a BWP for communications based on the FMCW-based channel estimation. In some examples, the UE 115-a may transmit an indication of the narrowband baseband processing capability 240 of the UE 115-a (e.g., in capability signaling) to the network entity 105-a. The capability signaling may indicate that the UE 115-a supports channel estimation for the wideband channel 225 using signaling via a narrowband channel (e.g., the first BWP 230 from a set of supported BWPs of the wideband channel 225). Additionally, or alternatively, the UE 115-a may receive, via the first BWP 230, an indication of a resource occasion for communication of a scrambled FMCW signal. Accordingly, the UE 115-a may receive, via the resource occasion of the first BWP 230, the scrambled FMCW signal. The UE 115-a may perform a channel estimation procedure (e.g., FMCW-based estimation of the channel 205) based on samples of a combined FMCW signal (e.g., narrowband signal), where the combined FMCW signal includes a combination of the received scrambled FMCW signal (e.g., a wideband signal) and a second FMCW signal generated at the UE 115-a (e.g., a local FMCW). The UE 115-a may estimate the channel 205 over the set of BWPs (e.g., associated with the wideband channel 225), such that the UE 115-a may effectively identify and select one or more BWPs (e.g., a second BWP 235) from the set of BWPs supported by the wideband channel 225 based on the channel estimation procedure.

In some cases, the coexistence of multiple transceivers (e.g., network entities 105 or UEs 115) transmitting FMCW signaling within the wireless communications system 200 may negatively affect a sensing functionality of a transceiver at a wireless device. For example, multiple transceivers communicating or performing sensing operations within an area (e.g., a cell) may cause interference to other transceivers. In some cases, the interference caused by the transceivers may decrease a capability of a wireless device to effectively sense (e.g., detect) communications, devices, or both within the wireless communications system 200. In some cases, a transceiver may fail to detect identifier information (e.g., a UE ID in uplink or a cell ID in downlink) for a device that transmitted an FMCW signal when the transceiver receives the FMCW signal, for example, if the FMCW signal is unscrambled. In some examples, the received unscrambled FMCW signal may also be interfered with by one or more other FMCW signals.

The techniques described herein may support FD-scrambled FMCW signaling. For example, a transmitter device (e.g., the network entity 105-a) may scramble an FMCW signal in the FD and transmit scrambled FMCW signaling 220 to a receiver device (e.g., the UE 115-a). The receiver device may de-scramble the scrambled FMCW signaling 220 to measure the channel 205 (e.g., perform channel estimation using the signaling). For example, the devices may use the FD-scrambled FMCW signaling to support channel estimation for any type of channel (e.g., a downlink data channel, a downlink control channel, an uplink data channel, an uplink control channel, a sidelink data channel, a sidelink control channel, a wireless backhaul channel, or any other channel).

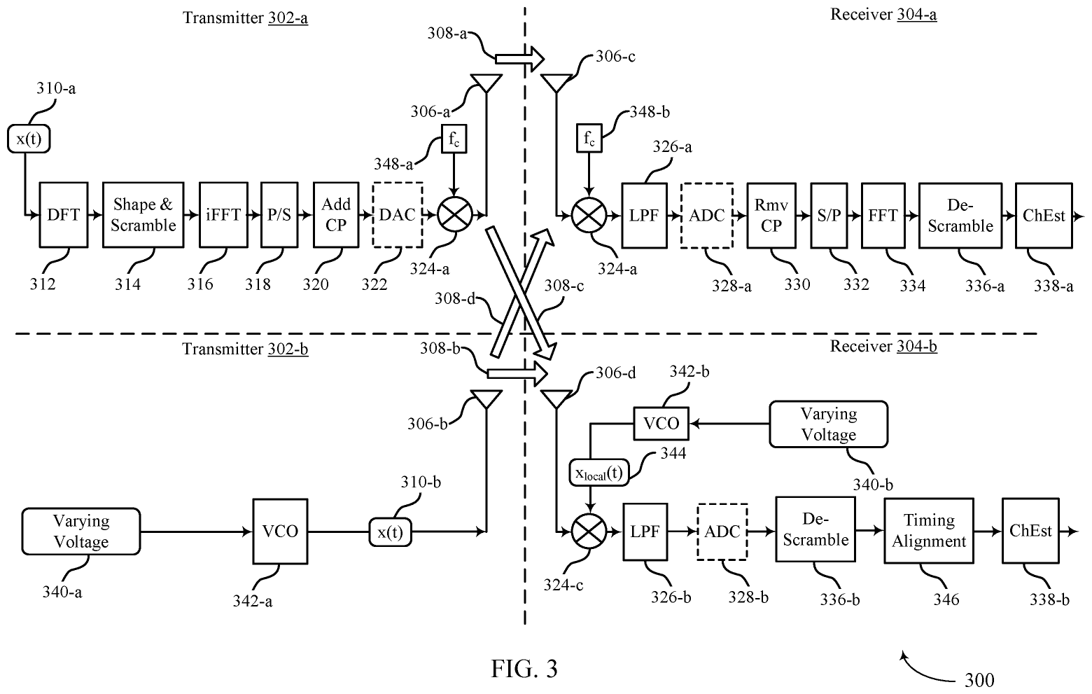

In some examples, the transmitter device may transmit configuration signaling 210. For example, the configuration signaling 210 may indicate an FD scrambling sequence used by the transmitter device to scramble the scrambled FMCW signaling 220. Additionally, or alternatively, the transmitter device may transmit a sequence indication 215 indicating how the receiver device can determine the FD scrambling sequence (e.g., based on an algorithm, one or more IDs, or any other FD scrambling sequence determination method). The transmitter device and the receiver device are discussed in further detail with reference to FIG. 3.

FIG. 3 shows an example of transmitter and receiver processes 300 that support FD-scrambled FMCW signaling in accordance with one or more aspects of the present disclosure. In some examples, the transmitter and receiver processes 300 may implement or be implemented by aspects of the wireless communications system 100 or the wireless communications system 200, as described with reference to FIGS. 1 and 2. For example, one or more transmitters (e.g., a first transmitter 302-a and a second transmitter 302-b) and one or more receivers (e.g., a first receiver 304-a and a second receiver 304-b) configured to perform the transmitter and receiver processes 300 may be components of one or more network entities 105, one or more UEs 115, or both as described with reference to FIGS. 1 and 2. In some examples, a transmitter and a receiver may communicate scrambled FMCW signaling via a channel, such that the scrambled FMCW signaling may be used to facilitate channel estimation (e.g., channel estimation 338-a or channel estimation 338-b) of the channel by the receiver or otherwise by the receiving device.

In some examples, the transmitter 302-a (e.g., a digital transmitter) may transmit an FMCW signal 308-a (e.g., a wideband signal) using an antenna 306-a (e.g., one or more antennas, antenna elements, antenna ports, antenna arrays, or any combination thereof) to the receiver 304-a (e.g., a digital receiver). The receiver 304-a may receive the FMCW signal 308-a using an antenna 306-c (e.g., one or more antennas, antenna elements, antenna ports, antenna arrays, or any combination thereof). Additionally, or alternatively, the transmitter 302-a may transmit an FMCW signal 308-c to the receiver 304-b (e.g., an analog receiver). The receiver 304-b may receive the FMCW signal 308-c using an antenna 306-d (e.g., one or more antennas, antenna elements, antenna ports, antenna arrays, or any combination thereof). In some examples, the transmitter 302-b (e.g., an analog transmitter) may transmit an FMCW signal 308-d (e.g., a wideband signal) using an antenna 306-b (e.g., one or more antennas, antenna elements, antenna ports, antenna arrays, or any combination thereof) to the receiver 304-a. Additionally, or alternatively, the transmitter 302-b may transmit an FMCW signal 308-b to the receiver 304-b.

In some cases, the transmitter 302-a may generate an FMCW signal 310-a (e.g., x(t)). The FMCW signal 310-a may be a carrier frequency signal

$$( e . g . , {e}^{j 2 π ( {f}_{c} + \frac{S}{2} t ) t} )$$

in the analog domain. In some examples, the transmitter 302-a may perform a discrete Fourier transform (DFT) 312 on the FMCW signal 310-a to produce a discrete FMCW signal (e.g., X(k)). The transmitter 302-a may perform the DFT 312 using one or more components (e.g., hardware, software, or both) configured to produce a DFT of one or more signals.

In some examples, the transmitter 302-a may shape and scramble 314 the discrete FMCW signal (e.g., the FMCW FD sequence, X(k)) with an FD scrambling sequence (e.g., A(k)) to produce a shaped and scrambled FMCW signal (e.g., A(k)*X(k)) in the FD. The FD scrambling sequence may be based on an algorithm, a lookup table, a device ID (e.g., cell ID, UE ID), or some combination thereof. In some cases, the transmitter 302-a may perform the scrambling during FD signal processing.

The transmitter 302-a may perform an inverse Fast Fourier transform (iFFT) 316 on the shaped and scrambled FMCW signal. The iFFT 316 may convert the signal from the FD to a time domain signal. That is, the iFFT 316 may produce a set of digital signals for transmission via time and frequency resources, the digital signals shaped and-a may modify the time domain digital signals from parallel to serial 318. In some examples, the transmitter 302-a may perform cyclic prefix (CP) addition 320 to add one or more CP(s) to the time domain digital signals. In some cases, the transmitter 302-a may use a digital-to-analog converter (DAC) 322 to convert the time domain digital signals to one or more time domain analog signals.

In some examples, the transmitter 302-a may combine the time domain analog signal with a carrier frequency signal 348-a using a mixer 324-a. The mixer 324-a may include one or more components (e.g., hardware, software, or both) of the transmitter 302-a that are configured to combine two or more signals. In some cases, the output of the mixer may be the FMCW signal 308-a or the FMCW signal 308-c, which may be examples of wideband signals. For example, an FMCW signal (e.g., a wideband signal or other signal) may represent H(k)*A(k)*X(k) in the FD, where H(k) may represent the FD channel at tone k (e.g., at a serving cell), A(k) may represent the FD scrambling sequence, and X(k) may represent the FMCW FD sequence. In some examples, the transmitter 302-a may transmit the FMCW signal 308-a to the receiver 304-a. Additionally, or alternatively, the transmitter 302-a may transmit the FMCW signal 308-c to the receiver 304-b.

In some examples, the transmitter 302-b a may generate an FMCW signal 310-b (e.g., a wideband signal, x(t)) for channel estimation of a channel using a voltage-controlled oscillator (VCO) 342-a on a varying voltage 340-a. The transmitter 302-b may transmit (e.g., unicast, groupcast, multicast, or broadcast) the FMCW signal 308-b or the FMCW signal 308-d via the channel using at least one antenna 306-b of the transmitter 302-b. In some examples, the transmitter 302-b may transmit the FMCW signal 308-d to the receiver 304-a. Additionally, or alternatively, the transmitter 302-b may transmit the FMCW signal 308-b to the receiver 304-b.

In some cases, the receiver 304-a (e.g., a digital receiver) may receive at least a portion of an FMCW signal (e.g., at least a portion of a wideband signal) for channel estimation 338-a. For example, the receiver 304-a may receive the FMCW signal 308-a or the FMCW signal 308-d transmitted by the transmitter 302-a or the transmitter 302-b, respectively. The received FMCW signal in the FD, Y(k), may be represented by Y(k)=H(k)*A(k)*X(k)+H_{I}(k)*B(k)*X(k), including both the transmitted FMCW signal and potential interference from one or more neighboring (e.g., interfering) FMCW signals. For example, H(k) represents a first FD channel at tone k (e.g., at a serving cell), A(k) represents the FD scrambling sequence used by the transmitter, X(k) represents the FMCW FD sequence (e.g., the sequence used by one or more transmitters), H_{I}(k) represents a second FD channel at tone k (e.g., at a neighboring cell), and B(k) represents an FD scrambling sequence used by a neighboring device (e.g., an interfering device). In some examples, the receiver 304-a may generate a combined FMCW signal. To generate the combined FMCW signal, the receiver 304-a may combine at least a portion of the received FMCW signal with a carrier frequency signal 348-b using a mixer 324-a. In some examples, the carrier frequency signal 348-b may be the same as the carrier frequency signal 348-a applied by the transmitter 302-a. The mixer 324-a may include one or more components (e.g., hardware, software, or both) that are configured to combine two or more signals.

The receiver 304-a may filter the combined FMCW signal using a low pass filter (LPF) 326-a. The LPF 326-a may generate a combined and filtered FMCW signal. The LPF 326-a may be an example of a component of the receiver 304-a that is configured to filter signals, or a function supported by the receiver 304-a, or both. For example, the receiver 304-a may apply an LPF function to the combined FMCW signal. In some examples, the receiver 304-a may use an analog-to-digital converter (ADC) 328-a to sample the combined and filtered FMCW signal in the time domain. A sampling rate used to sample the combined and filtered FMCW signal may be based on one or more parameters (e.g., a de-scrambling process by the receiver 304-a).

The receiver 304-a may perform CP removal 330 to remove one or more CPs from the combined and filtered FMCW signal. The receiver 304-b may modify the combined and filtered FMCW signal from serial to parallel 332, and the receiver 304-b may perform a Fast Fourier transform (FFT) 334 on the combined and filtered FMCW signal. The FFT 334 may convert the filtered and combined FMCW signal from the time domain to the FD. That is, the FFT 334 may support demodulation of the filtered and combined FMCW signal.

The receiver 304-a may de-scramble 336-a the FD FMCW signal, for example, according to an FD scrambling sequence (e.g., A(k)). The receiver 304-a may perform the de-scrambling using one or more components (e.g., hardware, software, or both) that are configured to de-scramble 336-a the signals in the FD. For example, the output of the ADC 328-a may represent H(k)*A(k)+H_{I}(k)*B(k) in the FD.

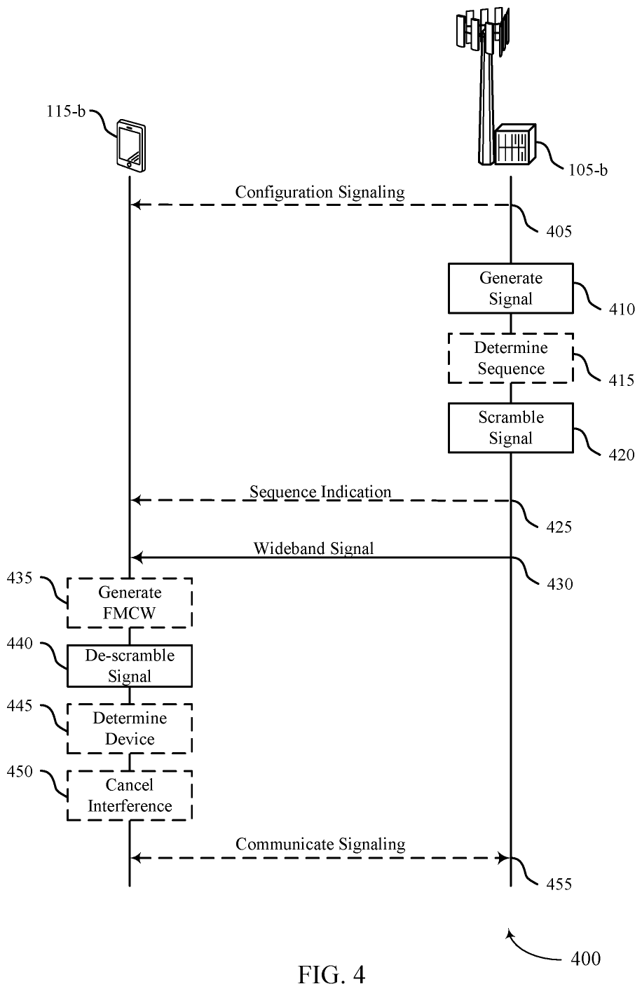

In some examples, the receiver 304-a may de-scramble 336-a the output of the ADC 328-a according to the FD scrambling sequence. In some examples, the de-scrambling may refrain from increasing (e.g., may not affect) the sampling rate of the ADC 328-a. In some cases, the receiver 304-a may receive an indication or configuration signaling of the FD scrambling sequence, as described with reference to FIG. 4. In some examples, an output of the de-scrambling 336-a may include a first sequence and a second sequence. For example, the de-scrambling 336-a may output a signal H(k)*A(k)*A(k)′+H_{I}(k)*B(k)*A(k)′, where A(k)*A(k)′ may be a first sequence based on the FD scrambling sequence, and B(k)*A(k)′ may be a second sequence (e.g., a random sequence) based on a scrambling sequence in the second FD channel.

The receiver 304-a may perform channel estimation 338-a based on the output of the de-scrambling 336-a. By de-scrambling signals for channel estimation 338-a, the receiver 304-a may differentiate different FMCW signals transmitted by different transmitters (e.g., different cells, different network entities 105, different UEs 115). Based on the channel estimation 338-a, the receiver 304-a may determine one or more channel metrics for the channel over which the receiver 304-a received the FMCW signal. In some cases, the receiver 304-a may estimate a wideband channel based on receiving and processing a portion (e.g., a narrowband portion) of a wideband FMCW signal.

In some examples, the receiver 304-b (e.g., an analog receiver) may receive at least a portion of an FMCW signal (e.g., the FMCW signal 308-b or the FMCW signal 308-c transmitted by the transmitter 302-b or the transmitter 302-a, respectively), which may be an example of a wideband signal, for channel estimation 338-b. Additionally, the receiver 304-b a may generate an FMCW signal 344 (e.g., a local FMCW signal x_{local}(t)) at the receiver 304-b using a VCO 342-b on a varying voltage 340-b. In some cases, the FMCW signal 344 may be an example of a local carrier frequency signal

$$( e . g . , {e}^{j 2 π ( {f}_{c} + \frac{S}{2} t ) t} )$$

in the analog domain. The local FMCW signal 344 generated at the receiver 304-b may have similar FMCW structures as the FMCW signal 308-b or the FMCW signal 308-c transmitted by the transmitter 302-b and the transmitter 302-a, respectively. That is, the exponential function representing the local FMCW signal 344 generated by the receiver 304-b may be designed for channel estimation 338-b, for example, with a received FMCW signal.

The receiver 304-b may generate a combined FMCW signal using the received FMCW signal and the generated local FMCW signal 344. To generate the combined FMCW signal, the receiver 304-b may combine the received FMCW signal (e.g., a portion of a wideband signal) with the locally generated FMCW signal 344 using a mixer 324-c. The mixer 324-c may include one or more components (e.g., hardware, software, or both) that are configured to combine two or more signals.

The receiver 304-b may filter the combined FMCW signal using an LPF 326-b by applying an LPF function to the combined FMCW signal. The LPF 326-b may generate a combined and filtered FMCW signal. The LPF 326-b may be an example of a component of the receiver 304-b that is configured to filter signals or a function supported by the receiver 304-b. In some examples, the receiver 304-b may use an ADC 328-b to sample the combined and filtered FMCW signal in the time domain. In some examples, the output of the ADC 328-b may be an example of (or similar to) a multiplication (e.g., A(k)*H(k)) of a scrambling sequence (e.g., A(k)) and the FD channel at a tone k (e.g., H(k)) in the FD. A sampling rate used to sample the combined and filtered FMCW signals may be based on one or more parameters. In some cases, the sampling rate (e.g., ADC rate) for the receiver 304-b may be relatively lower compared to a digital receiver.

The receiver 304-b may de-scramble 336-b the output of the ADC 328-b according to an FD scrambling sequence. The receiver 304-b may perform the de-scrambling 336-b using one or more components (e.g., hardware, software, or both) configured to de-scramble 336-b FMCW signals. In some cases, the receiver 304-b may de-scramble 336-b the FMCW signal during time domain signal processing. The output of the ADC 328-b may include a signal represented by H(k)*A(k)+H_{I}(k)*B(k) in the FD, where H(k) represents a first FD channel at tone k (e.g., at a serving cell), H_{I}(k) represents a second FD channel at tone k (e.g., at a neighboring cell), A(k) represents the FD scrambling sequence, and B(k) represents an FD scrambling sequence in the second FD channel.

The receiver 304-b may de-scramble 336-b the output of the ADC 328-b according to the FD scrambling sequence. In some examples, the de-scrambling may not affect the sampling rate of the ADC 328-b. In some cases, the receiver 304-b may receive an indication or configuration signaling of the FD scrambling sequence, as described with reference to FIG. 4. In some examples, an output of the de-scrambling 336-b may include a first sequence and a second sequence. For example, the output may be represented by H(k)*A(k)*A(k)′+H_{I}(k)*B(k)*A(k)′, where A(k)*A(k)′ may be a first sequence based on the FD scrambling sequence, and B(k)*A(k)′ may be a second sequence (e.g., a random sequence) based on a scrambling sequence in the second FD channel.

The receiver 304-b may perform a timing alignment 346 on the output of the de-scrambling process. In some examples, the output of the timing alignment 346 may be a subsampled FD channel estimate of the channel. The receiver 304-b may thereby de-scramble FMCW signals for channel estimation 338-b. By de-scrambling FMCW signals for channel estimation 338-b using the FD scrambling sequence, the receiver 304-b may differentiate different FMCW signals transmitted by different transmitters (e.g., different cells, network entities 105, or UEs 115).

In some examples, the receiver 304-a, the receiver 304-b, or both may perform interference cancelation on the received FMCW signals. For example, the receivers may apply an iFFT to the output of the de-scrambling 336-a or the de-scrambling 336-b. In some cases, the output of the iFFT may be represented by h(t)⊗pulse+h_{I}(t)⊗noise, where the pulse may be the iFFT output of the first sequence based on the FD scrambling sequence (e.g., A(k)*A(k)′), and the noise may be the iFFT output of the second sequence based on the scrambling sequence in the second FD channel (e.g., B(k)*A(k)′). The receivers may filter and separate the results of the iFFT applied to the output of the de-scrambling process to perform interference cancelation of other transmitted signals.

FIG. 4 shows an example of a process flow 400 that supports FD-scrambled FMCW signaling in accordance with one or more aspects of the present disclosure. The process flow 400 may be performed by aspects of the wireless communications system 100 or the wireless communications system 200, as described herein with reference to FIGS. 1 and 2. For example, a UE 115-b and a network entity 105-b, which may be examples of a UE 115 and a network entity 105 as described herein, may perform aspects of the process flow 400. In the following description of the process flow 400, operations performed by the UE 115-b and the network entity 105-b may be performed in a different order than is shown. Some operations may be omitted from the process flow 400, and other operations may be added to the process flow 400. Further, although some operations or signaling may be shown to occur at different times for discussion purposes, these operations may occur at the same time. Additionally, or alternatively, other wireless devices may perform aspects of the process flow 400. For example, a UE 115 may operate as a transmitting device, a receiving device, or both with reference to the operations of the process flow 400, and a network entity 105 may operate as a transmitting device, a receiving device, or both with reference to the operations of the process flow 400.

In some examples, at 405, the network entity 105-b may transmit configuration signaling to the UE 115-b. In some cases, the configuration signaling may indicate an FD scrambling sequence corresponding to the network entity 105-b. For example, the network entity 105-b may transmit configuration signaling indicating the FD scrambling sequence to the UE 115-b for an FD-scrambled digital FMCW transmission. The configuration signaling may be an example of RRC signaling, a MAC control element (CE), downlink control information (DCI) signaling, or any other configuration signaling.

At 410, the network entity 105-b may generate an FD representation of a reference signal. In some examples, the FD representation of the reference signal may be based on a DFT of an FMCW. In some examples, at 415, the network entity 105-b may determine the FD scrambling sequence. In some cases, the network entity 105-b may determine the FD scrambling sequence according to an algorithm. In some cases, the algorithm may be based on a digital modulation scheme (e.g., binary phase-shift keying (BPSK) or some other modulation scheme). In some examples, a length of the FD scrambling sequence (e.g., a length n) may be based on a capability of the UE 115-b. For example, the capability of the UE 115-b may be an example of, or based on, a baseband bandwidth processing capability, an analog receiving capability (e.g., if the UE 115-b includes an analog receiver or transceiver), a digital receiving capability (e.g., if the UE 115-b includes a digital receiver or transceiver), or any combination thereof.

At 420, the network entity 105-b may scramble the FD representation of the reference signal using the FD scrambling sequence. In some examples, the scrambling (e.g., the FD scrambling sequence) may be based on the configuration signaling. In some other examples, the scrambling (e.g., the FD scrambling sequence) may be based on an ID (e.g., a cell ID) of the network entity 105-b, an ID of the UE 115-b, or both. Additionally, or alternatively, the scrambling may include scrambling multiple sets of contiguous frequency resources (e.g., consecutive resource elements (REs) or consecutive resource blocks (RBs)) based on the length of the FD scrambling sequence. In some examples, each set of the multiple sets of contiguous frequency resources is scrambled using a respective bit of the FD scrambling sequence. For example, for a bandwidth spanning N frequency resources and an FD scrambling sequence of length n, a quantity of contiguous frequency resources of N divided by n (e.g., rounded up according to a ceiling function) may be scrambled using a bit of the FD scrambling sequence. In some cases, the expected or predicted narrowband baseband bandwidth may be based on the FD scrambling sequence length (e.g., a relatively longer length n may increase the expected or predicted narrowband baseband bandwidth).

In some cases, at 425, the UE 115-b may receive an indication to determine the FD scrambling sequence. In some examples, the indication may be based on an ID of the network entity 105-b, an ID of the UE 115-b, or both. For example, the network entity 105-b may indicate for the UE 115-b to use, or reuse, a cell ID, UE-ID, or the like to determine the FD scrambling sequence for FD-scrambled FMCW transmissions.

At 430, the network entity 105-b may transmit a wideband signal for channel estimation of a channel based on the scrambled FD representation of the reference signal. For example, the wideband signal may be an example of an FD-scrambled FMCW transmission based on the FD scrambling sequence for the network entity 105-b. The UE 115-b may receive at least a portion of the wideband signal. In some examples, the wideband signal may enable channel estimation of the channel at the UE 115-b.

In some cases, at 435, the UE 115-b may generate an FMCW (e.g., a local FMCW). In some examples, the local FMCW may be generated based on the UE 115-b including an analog receiver. At 440, the UE 115-b may de-scramble a portion of the wideband signal using the FD scrambling sequence. In some examples, the UE 115-b may de-scramble the portion of the wideband signal based on the generated FMCW at the UE 115-b. Additionally, or alternatively, the UE 115-b may de-scramble the portion according to an ID of the UE 115-b.

In some examples, at 445, the UE 115-b may determine that the network entity 105-b transmitted the wideband signal based on successfully de-scrambling the portion of the wideband signal using the FD scrambling sequence corresponding to the network entity 105-b. For example, the UE 115-b may determine an ID of the network entity 105-b based on de-scrambling the portion of the wideband signal. In some cases, at 450, the UE 115-b may perform interference cancelation of at least a second network entity 105, a second UE 115, or both. In some examples, the interference cancelation may be based on determining that the network entity 105-b transmitted the wideband signal. The UE 115-b may perform interference cancelation to mitigate interference from other FMCW transmissions detected or received via the channel.

At 455, the UE 115-b may communicate signaling with the network entity 105-b via the channel. In some examples, the UE 115-b may communicate the signaling according to the channel estimation of the channel based on the de-scrambled portion of the wideband signal.

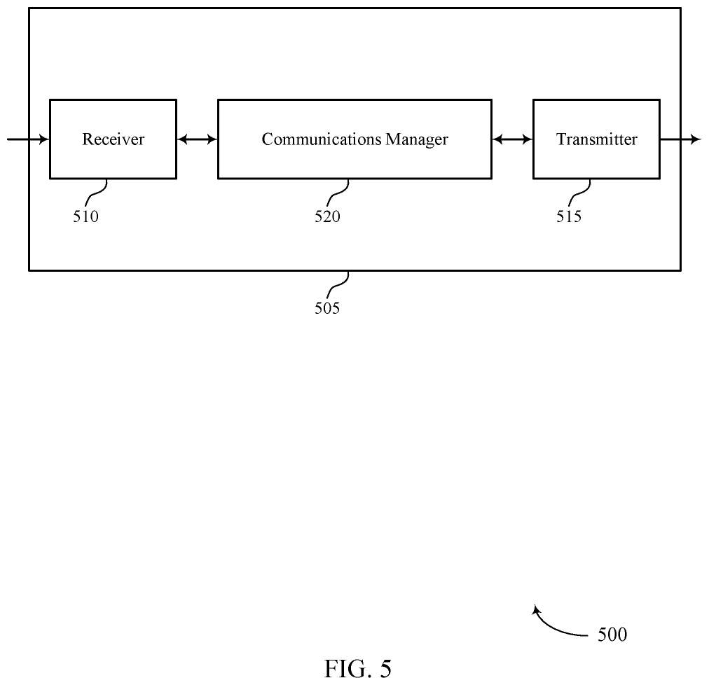

FIG. 5 shows a block diagram 500 of a device 505 that supports FD-scrambled FMCW signaling in accordance with one or more aspects of the present disclosure. The device 505 may be an example of aspects of a UE 115 or a network entity 105 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to FD-scrambled FMCW signaling). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to FD-scrambled FMCW signaling). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of FD-scrambled FMCW signaling as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The receiver 510 may be an example or a component of an analog receiver, a digital receiver, an analog transceiver, or a digital transceiver. Similarly, the transmitter 515 may be an example or a component of an analog transmitter, a digital transmitter, an analog transceiver, or a digital transceiver.

In some examples, the communications manager 520 may support wireless communications at a first wireless device in accordance with examples as disclosed herein. For example, the communications manager 520 is capable of, configured to, or operable to support a means for generating an FD representation of a reference signal based on a DFT of an FMCW. The communications manager 520 is capable of, configured to, or operable to support a means for scrambling the FD representation of the reference signal using an FD scrambling sequence corresponding to the first wireless device. The communications manager 520 is capable of, configured to, or operable to support a means for transmitting a wideband signal for channel estimation of a channel at a second wireless device based on the scrambled FD representation of the reference signal.

Additionally, or alternatively, the communications manager 520 may support wireless communications at a second wireless device in accordance with examples as disclosed herein. For example, the communications manager 520 is capable of, configured to, or operable to support a means for receiving at least a portion of a wideband signal for channel estimation of a channel, the wideband signal associated with a first wireless device and based on an FMCW. The communications manager 520 is capable of, configured to, or operable to support a means for de-scrambling the portion of the wideband signal using an FD scrambling sequence corresponding to the first wireless device. The communications manager 520 is capable of, configured to, or operable to support a means for communicating signaling via the channel according to the channel estimation of the channel based on the de-scrambled portion of the wideband signal.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption (e.g., by measuring wideband channel using a narrowband baseband chain), and more efficient utilization of communication resources. For example, the device 505 may reduce a processing overhead associated with retransmissions based on supporting interference cancelation (e.g., effectively improving communication reliability and sensing) in accordance with successful de-scrambling of FMCW signaling.

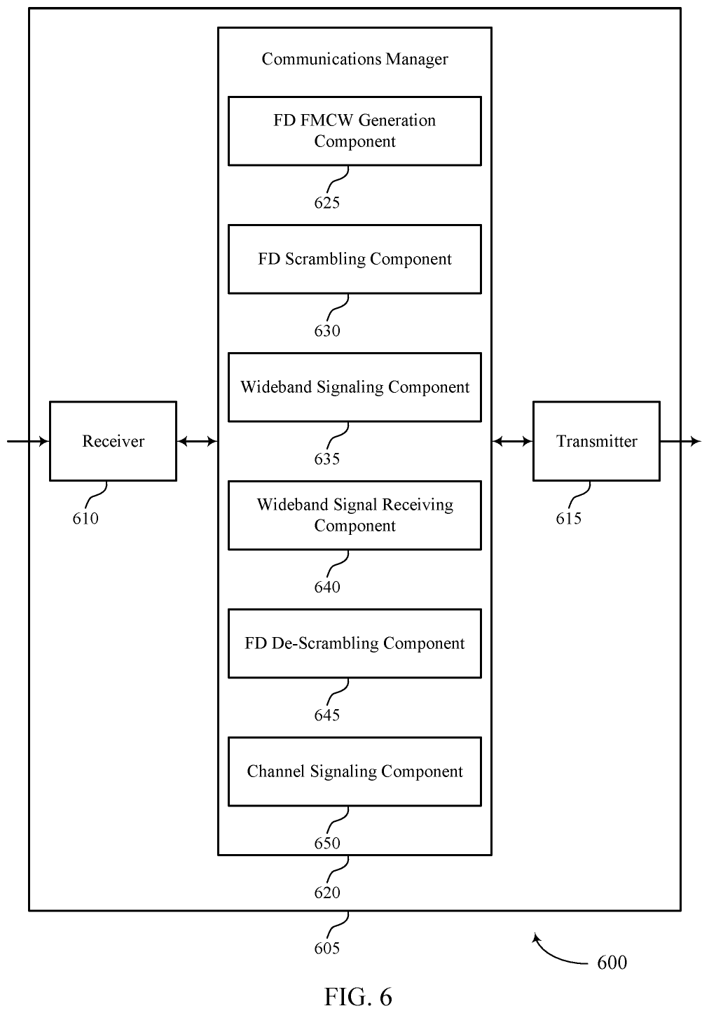

FIG. 6 shows a block diagram 600 of a device 605 that supports FD-scrambled FMCW signaling in accordance with one or more aspects of the present disclosure. The device 605 may be an example of aspects of a device 505, a UE 115, or a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to FD-scrambled FMCW signaling). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to FD-scrambled FMCW signaling). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of FD-scrambled FMCW signaling as described herein. For example, the communications manager 620 may include an FD FMCW generation component 625, an FD scrambling component 630, a wideband signaling component 635, a wideband signal receiving component 640, an FD de-scrambling component 645, a channel signaling component 650, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first wireless device in accordance with examples as disclosed herein. The FD FMCW generation component 625 is capable of, configured to, or operable to support a means for generating an FD representation of a reference signal based on a DFT of an FMCW. The FD scrambling component 630 is capable of, configured to, or operable to support a means for scrambling the FD representation of the reference signal using an FD scrambling sequence corresponding to the first wireless device. The wideband signaling component 635 is capable of, configured to, or operable to support a means for transmitting a wideband signal for channel estimation of a channel at a second wireless device based on the scrambled FD representation of the reference signal.

Additionally, or alternatively, the communications manager 620 may support wireless communications at a second wireless device in accordance with examples as disclosed herein. The wideband signal receiving component 640 is capable of, configured to, or operable to support a means for receiving at least a portion of a wideband signal for channel estimation of a channel, the wideband signal associated with a first wireless device and based on an FMCW. The FD de-scrambling component 645 is capable of, configured to, or operable to support a means for de-scrambling the portion of the wideband signal using an FD scrambling sequence corresponding to the first wireless device. The channel signaling component 650 is capable of, configured to, or operable to support a means for communicating signaling via the channel according to the channel estimation of the channel based on the de-scrambled portion of the wideband signal.

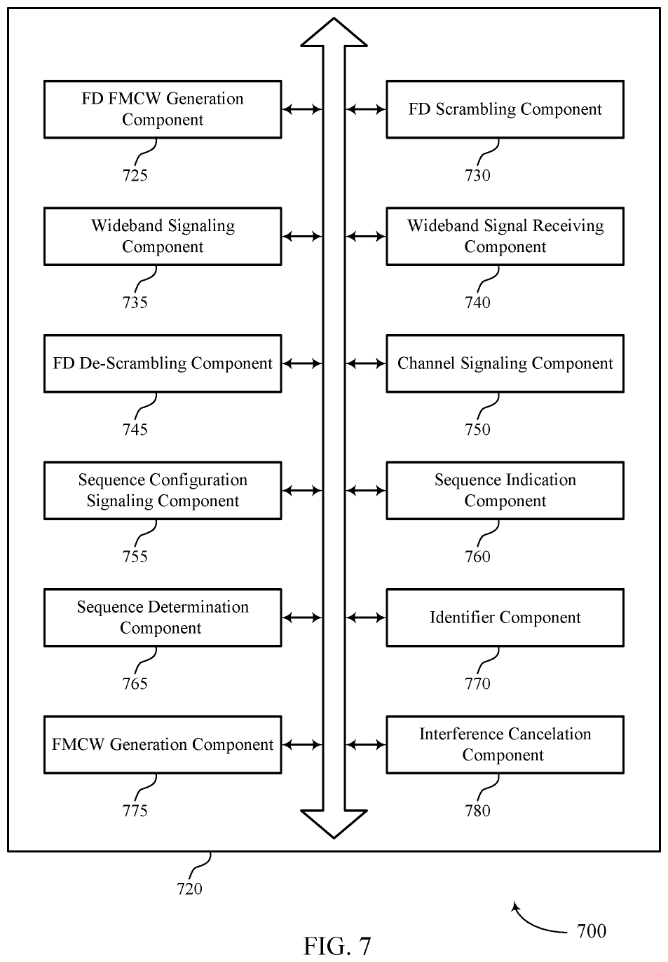

FIG. 7 shows a block diagram 700 of a communications manager 720 that supports FD-scrambled FMCW signaling in accordance with one or more aspects of the present disclosure. The communications manager 720 may be an example of aspects of a communications manager 520, a communications manager 620, or both, as described herein. The communications manager 720, or various components thereof, may be an example of means for performing various aspects of FD-scrambled FMCW signaling as described herein. For example, the communications manager 720 may include an FD FMCW generation component 725, an FD scrambling component 730, a wideband signaling component 735, a wideband signal receiving component 740, an FD de-scrambling component 745, a channel signaling component 750, a sequence configuration signaling component 755, a sequence indication component 760, a sequence determination component 765, an identifier component 770, an FMCW generation component 775, an interference cancelation component 780, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications at a first wireless device in accordance with examples as disclosed herein. The FD FMCW generation component 725 is capable of, configured to, or operable to support a means for generating an FD representation of a reference signal based on a DFT of an FMCW. The FD scrambling component 730 is capable of, configured to, or operable to support a means for scrambling the FD representation of the reference signal using an FD scrambling sequence corresponding to the first wireless device. The wideband signaling component 735 is capable of, configured to, or operable to support a means for transmitting a wideband signal for channel estimation of a channel at a second wireless device based on the scrambled FD representation of the reference signal.

In some examples, the channel signaling component 750 is capable of, configured to, or operable to support a means for communicating signaling via the channel according to the channel estimation of the channel based on the scrambled FD representation of the reference signal.

In some examples, the sequence configuration signaling component 755 is capable of, configured to, or operable to support a means for transmitting configuration signaling indicating the FD scrambling sequence corresponding to the first wireless device. In some examples, the configuration signaling includes an RRC signal, a MAC-CE signal, a DCI signal, or any combination thereof.

In some examples, the sequence indication component 760 is capable of, configured to, or operable to support a means for transmitting an indication to determine the FD scrambling sequence based on a cell ID associated with the first wireless device, a UE ID associated with the first wireless device, or any combination thereof.

In some examples, a length of the FD scrambling sequence is based on a capability of the second wireless device. In some examples, the capability of the second wireless device is based on a baseband bandwidth processing capability, an analog receiving capability, a digital receiving capability, or any combination thereof of the second wireless device.

In some examples, to support scrambling the FD representation of the reference signal, the FD scrambling component 730 is capable of, configured to, or operable to support a means for scrambling a set of multiple sets of contiguous frequency resources of the FD representation of the reference signal based on a length of the FD scrambling sequence, where a set of contiguous frequency resources within the set of multiple sets of contiguous frequency resources is scrambled using a respective bit of the FD scrambling sequence.

In some examples, to support transmitting the wideband signal, the wideband signaling component 735 is capable of, configured to, or operable to support a means for transmitting the wideband signal via a digital transceiver or an analog transceiver.

In some examples, the sequence determination component 765 is capable of, configured to, or operable to support a means for determining the FD scrambling sequence based on a digital modulation scheme of the first wireless device, a cell ID associated with the first wireless device, a UE ID associated with the first wireless device, or any combination thereof.

Additionally, or alternatively, the communications manager 720 may support wireless communications at a second wireless device in accordance with examples as disclosed herein. The wideband signal receiving component 740 is capable of, configured to, or operable to support a means for receiving at least a portion of a wideband signal for channel estimation of a channel, the wideband signal associated with a first wireless device and based on an FMCW. The FD de-scrambling component 745 is capable of, configured to, or operable to support a means for de-scrambling the portion of the wideband signal using an FD scrambling sequence corresponding to the first wireless device. The channel signaling component 750 is capable of, configured to, or operable to support a means for communicating signaling via the channel according to the channel estimation of the channel based on the de-scrambled portion of the wideband signal.

In some examples, the identifier component 770 is capable of, configured to, or operable to support a means for determining an ID of the first wireless device associated with the wideband signal based on de-scrambling the portion of the wideband signal using the FD scrambling sequence. In some examples, the interference cancelation component 780 is capable of, configured to, or operable to support a means for performing interference cancelation of additional signaling associated with a third wireless device based on the ID of the first wireless device associated with the wideband signal.

In some examples, the sequence configuration signaling component 755 is capable of, configured to, or operable to support a means for receiving configuration signaling indicating the FD scrambling sequence. In some examples, the configuration signaling includes an RRC signal, a MAC-CE signal, a DCI signal, or any combination thereof.

In some examples, the sequence determination component 765 is capable of, configured to, or operable to support a means for receiving an indication to determine the FD scrambling sequence based on a cell ID associated with the first wireless device, a UE ID associated with the first wireless device, or any combination thereof. In some examples, the sequence determination component 765 is capable of, configured to, or operable to support a means for determining the FD scrambling sequence based on the indication.

In some examples, a length of the FD scrambling sequence is based on a capability of the second wireless device. In some examples, the capability of the second wireless device is based on a baseband bandwidth processing capability, an analog receiving capability, a digital receiving capability, or any combination thereof of the second wireless device.

In some examples, to support de-scrambling the portion of the wideband signal, the FD de-scrambling component 745 is capable of, configured to, or operable to support a means for de-scrambling a set of multiple sets of contiguous frequency resources corresponding to the portion of the wideband signal based on a length of the FD scrambling sequence, where a set of contiguous frequency resources within the set of multiple sets of contiguous frequency resources is de-scrambled using a respective bit of the FD scrambling sequence.

In some examples, to support receiving at least the portion of the wideband signal, the wideband signal receiving component 740 is capable of, configured to, or operable to support a means for receiving at least the portion of the wideband signal via a digital transceiver or an analog transceiver.

In some examples, to support de-scrambling the portion of the wideband signal, the FMCW generation component 775 is capable of, configured to, or operable to support a means for generating a local FMCW. In some examples, to support de-scrambling the portion of the wideband signal, the FD de-scrambling component 745 is capable of, configured to, or operable to support a means for de-scrambling the portion of the wideband signal based on combining the local FMCW with the FMCW corresponding to the wideband signal.

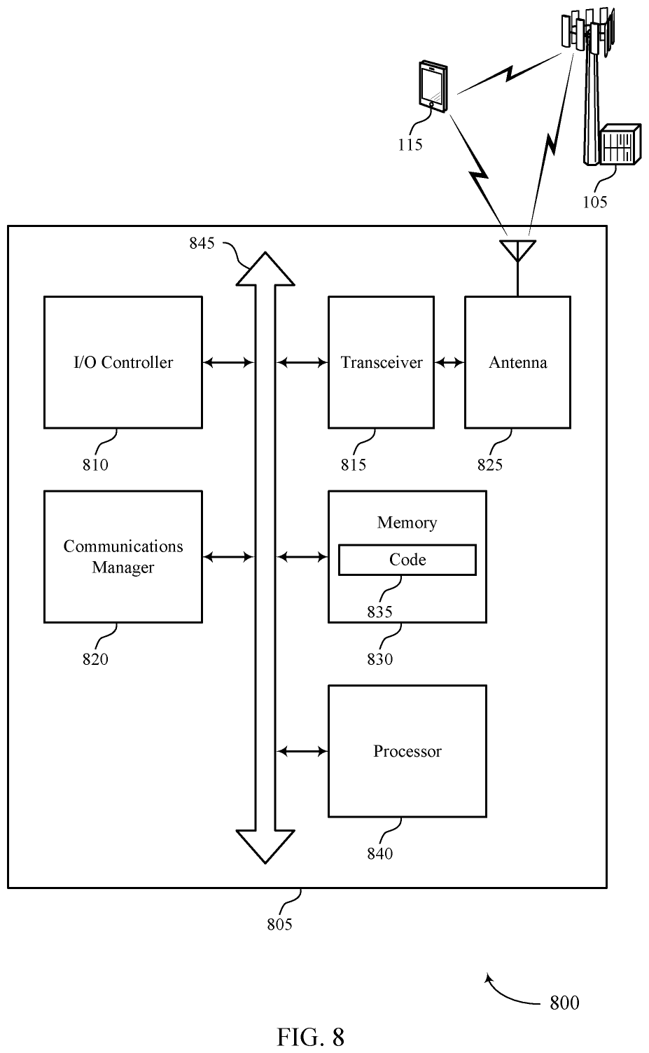

FIG. 8 shows a diagram of a system 800 including a device 805 that supports FD-scrambled FMCW signaling in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting FD-scrambled FMCW signaling). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications at a first wireless device in accordance with examples as disclosed herein. For example, the communications manager 820 is capable of, configured to, or operable to support a means for generating an FD representation of a reference signal based on a DFT of an FMCW. The communications manager 820 is capable of, configured to, or operable to support a means for scrambling the FD representation of the reference signal using an FD scrambling sequence corresponding to the first wireless device. The communications manager 820 is capable of, configured to, or operable to support a means for transmitting a wideband signal for channel estimation of a channel at a second wireless device based on the scrambled FD representation of the reference signal.

Additionally, or alternatively, the communications manager 820 may support wireless communications at a second wireless device in accordance with examples as disclosed herein. For example, the communications manager 820 is capable of, configured to, or operable to support a means for receiving at least a portion of a wideband signal for channel estimation of a channel, the wideband signal associated with a first wireless device and based on an FMCW. The communications manager 820 is capable of, configured to, or operable to support a means for de-scrambling the portion of the wideband signal using an FD scrambling sequence corresponding to the first wireless device. The communications manager 820 is capable of, configured to, or operable to support a means for communicating signaling via the channel according to the channel estimation of the channel based on the de-scrambled portion of the wideband signal.

By including or configuring the communications manager 820 in accordance with examples as described herein, the device 805 may support techniques for improved communication reliability, reduced latency, improved user experience related to reduced processing, reduced power consumption (e.g., by measuring a wideband channel using a narrowband baseband chain), more efficient utilization of communication resources, improved coordination between devices, longer battery life, and an improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. For example, the communications manager 820 may be configured to receive or transmit messages or other signaling as described herein via the transceiver 815. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of FD-scrambled FMCW signaling as described herein, or the at least one processor 840 and the at least one memory 830 may be otherwise configured to, individually or collectively, perform or support such operations.

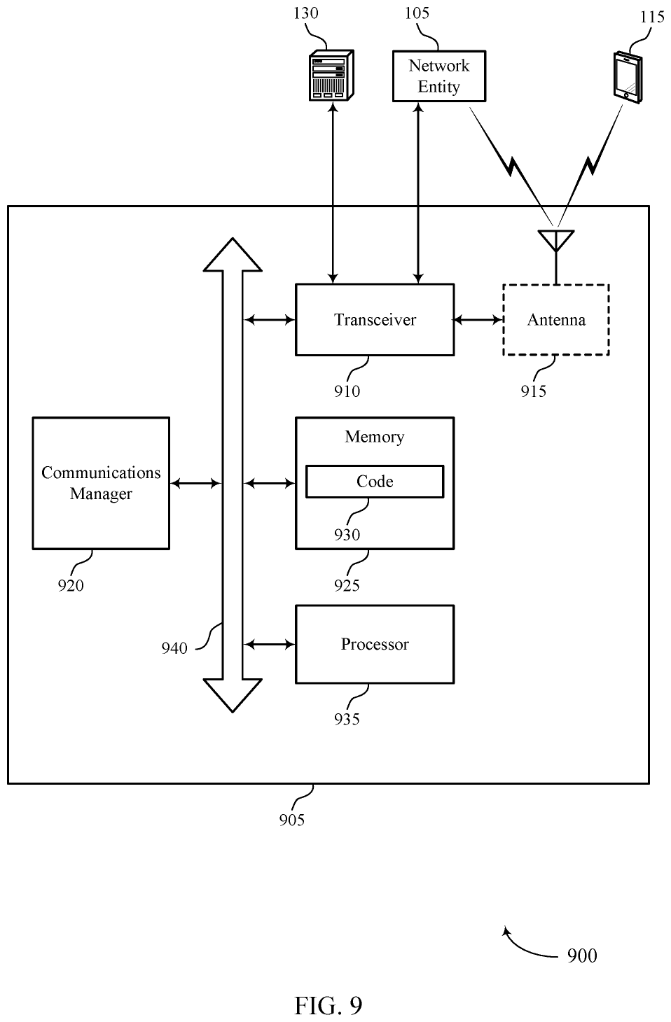

FIG. 9 shows a diagram of a system 900 including a device 905 that supports FD-scrambled FMCW signaling in accordance with one or more aspects of the present disclosure. The device 905 may be an example of or include the components of a device 505, a device 605, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., a communication link 125, a backhaul communication link 120, a midhaul communication link 162, a fronthaul communication link 168).

The at least one memory 925 may include RAM, ROM, or any combination thereof. The at least one memory 925 may store computer-readable, computer-executable code 930 including instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may contain, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting FD-scrambled FMCW signaling). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925).

In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. As such, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105 and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communications at a first wireless device in accordance with examples as disclosed herein. For example, the communications manager 920 is capable of, configured to, or operable to support a means for generating an FD representation of a reference signal based on a DFT of an FMCW. The communications manager 920 is capable of, configured to, or operable to support a means for scrambling the FD representation of the reference signal using an FD scrambling sequence corresponding to the first wireless device. The communications manager 920 is capable of, configured to, or operable to support a means for transmitting a wideband signal for channel estimation of a channel at a second wireless device based on the scrambled FD representation of the reference signal.

Additionally, or alternatively, the communications manager 920 may support wireless communications at a second wireless device in accordance with examples as disclosed herein. For example, the communications manager 920 is capable of, configured to, or operable to support a means for receiving at least a portion of a wideband signal for channel estimation of a channel, the wideband signal associated with a first wireless device and based on an FMCW. The communications manager 920 is capable of, configured to, or operable to support a means for de-scrambling the portion of the wideband signal using an FD scrambling sequence corresponding to the first wireless device. The communications manager 920 is capable of, configured to, or operable to support a means for communicating signaling via the channel according to the channel estimation of the channel based on the de-scrambled portion of the wideband signal.

By including or configuring the communications manager 920 in accordance with examples as described herein, the device 905 may support techniques for improved communication reliability, reduced latency, improved user experience related to reduced processing, reduced power consumption (e.g., by measuring a wideband channel using a narrowband baseband chain), more efficient utilization of communication resources, improved coordination between devices, longer battery life, and improved utilization of processing capability.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. For example, the communications manager 920 may be configured to receive or transmit messages or other signaling as described herein via the transceiver 910. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of FD-scrambled FMCW signaling as described herein, or the at least one processor 935 and the at least one memory 925 may be otherwise configured to, individually or collectively, perform or support such operations.

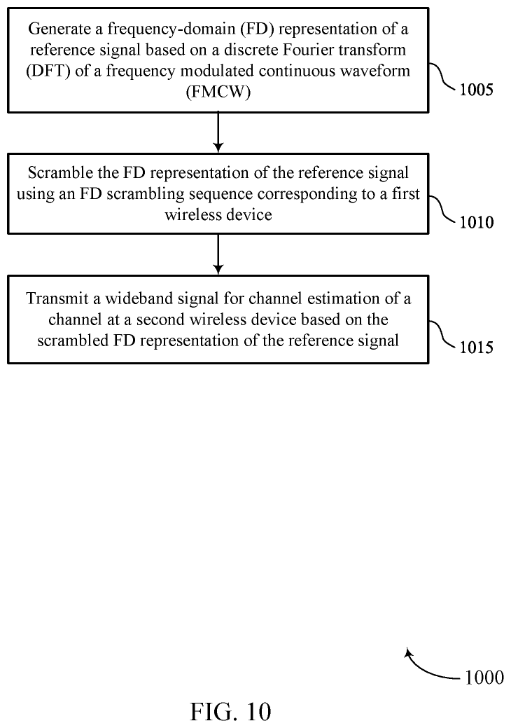

FIG. 10 shows a flowchart illustrating a method 1000 that supports FD-scrambled FMCW signaling in accordance with aspects of the present disclosure. The operations of the method 1000 may be implemented by a first wireless device, such as a UE or a network entity or components of a UE or network entity as described herein. For example, the operations of the method 1000 may be performed by a UE 115 or a network entity 105 as described with reference to FIGS. 1 through 9. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1005, the method may include generating an FD representation of a reference signal based on a DFT of an FMCW. The operations of block 1005 may be performed in accordance with examples as disclosed herein. In some examples, aspects of the operations of 1005 may be performed by an FD FMCW generation component 725 as described with reference to FIG. 7. In some cases, means for performing the operations of 1005 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1005 at a network entity 105 may include, for example, one or more antennas 915, a transceiver 910, a communications manager 920, one or more memories 925 (e.g., including code 930), one or more processors 935, one or more buses 940, or any combination thereof.

At 1010, the method may include scrambling the FD representation of the reference signal using an FD scrambling sequence corresponding to the first wireless device. The operations of block 1010 may be performed in accordance with examples as disclosed herein. In some examples, aspects of the operations of 1010 may be performed by an FD scrambling component 730 as described with reference to FIG. 7. In some cases, means for performing the operations of 1010 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1010 at a network entity 105 may include, for example, one or more antennas 915, a transceiver 910, a communications manager 920, one or more memories 925 (e.g., including code 930), one or more processors 935, one or more buses 940, or any combination thereof.

At 1015, the method may include transmitting a wideband signal for channel estimation of a channel at a second wireless device based on the scrambled FD representation of the reference signal. The operations of block 1015 may be performed in accordance with examples as disclosed herein. In some examples, aspects of the operations of 1015 may be performed by a wideband signaling component 735 as described with reference to FIG. 7. In some cases, means for performing the operations of 1015 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1015 at a network entity 105 may include, for example, one or more antennas 915, a transceiver 910, a communications manager 920, one or more memories 925 (e.g., including code 930), one or more processors 935, one or more buses 940, or any combination thereof.

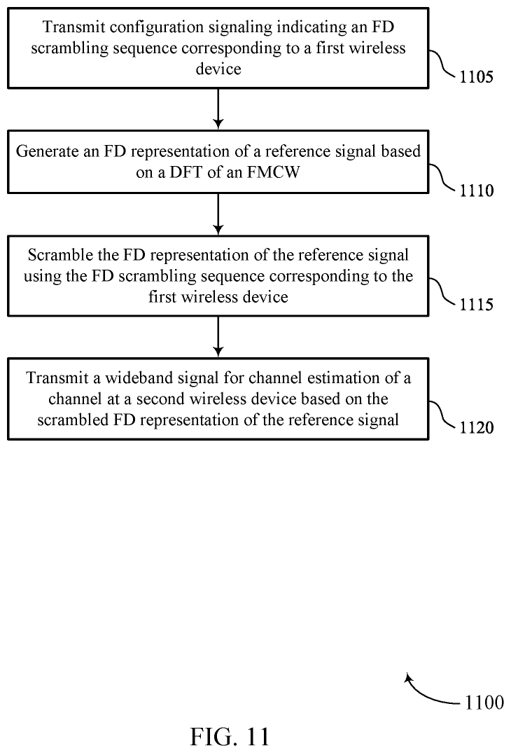

FIG. 11 shows a flowchart illustrating a method 1100 that supports FD-scrambled FMCW signaling in accordance with aspects of the present disclosure. The operations of the method 1100 may be implemented by a first wireless device, such as a UE or a network entity or components of a UE or network entity as described herein. For example, the operations of the method 1100 may be performed by a UE 115 or a network entity 105 as described with reference to FIGS. 1 through 9. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include transmitting configuration signaling indicating an FD scrambling sequence corresponding to the first wireless device. The operations of block 1105 may be performed in accordance with examples as disclosed herein. In some examples, aspects of the operations of 1105 may be performed by a sequence configuration signaling component 755 as described with reference to FIG. 7. In some cases, means for performing the operations of 1105 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1105 at a network entity 105 may include, for example, one or more antennas 915, a transceiver 910, a communications manager 920, one or more memories 925 (e.g., including code 930), one or more processors 935, one or more buses 940, or any combination thereof.

At 1110, the method may include generating an FD representation of a reference signal based on a DFT of an FMCW. The operations of block 1110 may be performed in accordance with examples as disclosed herein. In some examples, aspects of the operations of 1110 may be performed by an FD FMCW generation component 725 as described with reference to FIG. 7. In some cases, means for performing the operations of 1110 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1110 at a network entity 105 may include, for example, one or more antennas 915, a transceiver 910, a communications manager 920, one or more memories 925 (e.g., including code 930), one or more processors 935, one or more buses 940, or any combination thereof.

At 1115, the method may include scrambling the FD representation of the reference signal using the FD scrambling sequence corresponding to the first wireless device and indicated by the configuration signaling. The operations of block 1115 may be performed in accordance with examples as disclosed herein. In some examples, aspects of the operations of 1115 may be performed by an FD scrambling component 730 as described with reference to FIG. 7. In some cases, means for performing the operations of 1115 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1115 at a network entity 105 may include, for example, one or more antennas 915, a transceiver 910, a communications manager 920, one or more memories 925 (e.g., including code 930), one or more processors 935, one or more buses 940, or any combination thereof.

At 1120, the method may include transmitting a wideband signal for channel estimation of a channel at a second wireless device based on the scrambled FD representation of the reference signal. The operations of block 1120 may be performed in accordance with examples as disclosed herein. In some examples, aspects of the operations of 1120 may be performed by a wideband signaling component 735 as described with reference to FIG. 7. In some cases, means for performing the operations of 1120 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1120 at a network entity 105 may include, for example, one or more antennas 915, a transceiver 910, a communications manager 920, one or more memories 925 (e.g., including code 930), one or more processors 935, one or more buses 940, or any combination thereof.

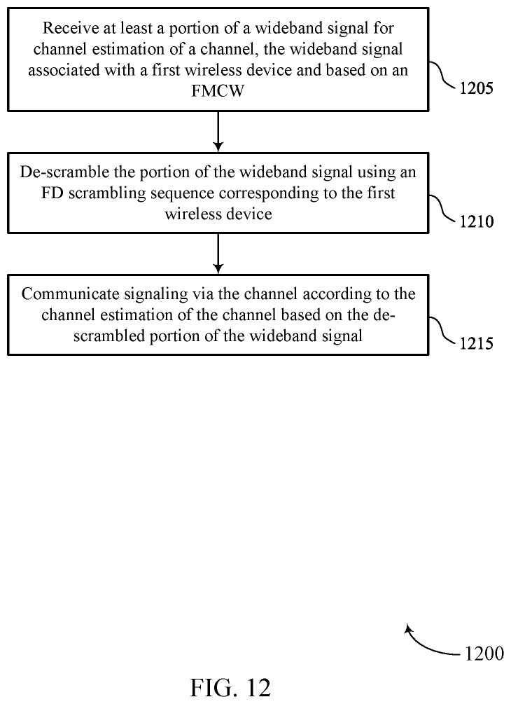

FIG. 12 shows a flowchart illustrating a method 1200 that supports FD-scrambled FMCW signaling in accordance with aspects of the present disclosure. The operations of the method 1200 may be implemented by a second wireless device, such as a UE or a network entity or components of a UE or network entity as described herein. For example, the operations of the method 1200 may be performed by a UE 115 or a network entity 105 as described with reference to FIGS. 1 through 9. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include receiving at least a portion of a wideband signal for channel estimation of a channel, the wideband signal associated with a first wireless device and based on an FMCW. The operations of block 1205 may be performed in accordance with examples as disclosed herein. In some examples, aspects of the operations of 1205 may be performed by a wideband signal receiving component 740 as described with reference to FIG. 7. In some cases, means for performing the operations of 1205 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1205 at a network entity 105 may include, for example, one or more antennas 915, a transceiver 910, a communications manager 920, one or more memories 925 (e.g., including code 930), one or more processors 935, one or more buses 940, or any combination thereof.

At 1210, the method may include de-scrambling the portion of the wideband signal using an FD scrambling sequence corresponding to the first wireless device. The operations of block 1210 may be performed in accordance with examples as disclosed herein. In some examples, aspects of the operations of 1210 may be performed by an FD de-scrambling component 745 as described with reference to FIG. 7. In some cases, means for performing the operations of 1210 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1210 at a network entity 105 may include, for example, one or more antennas 915, a transceiver 910, a communications manager 920, one or more memories 925 (e.g., including code 930), one or more processors 935, one or more buses 940, or any combination thereof.

At 1215, the method may include communicating signaling via the channel according to the channel estimation of the channel based on the de-scrambled portion of the wideband signal. The operations of block 1215 may be performed in accordance with examples as disclosed herein. In some examples, aspects of the operations of 1215 may be performed by a channel signaling component 750 as described with reference to FIG. 7. In some cases, means for performing the operations of 1215 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1215 at a network entity 105 may include, for example, one or more antennas 915, a transceiver 910, a communications manager 920, one or more memories 925 (e.g., including code 930), one or more processors 935, one or more buses 940, or any combination thereof.

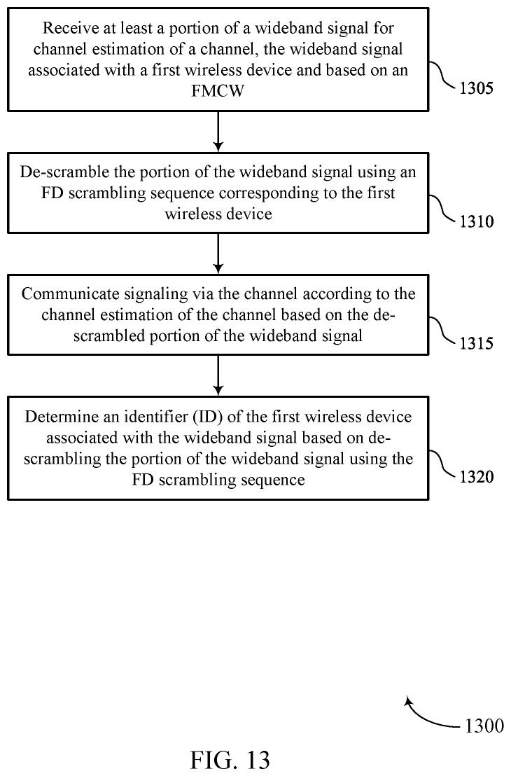

FIG. 13 shows a flowchart illustrating a method 1300 that supports FD-scrambled FMCW signaling in accordance with aspects of the present disclosure. The operations of the method 1300 may be implemented by a second wireless device, such as a UE or a network entity or components of a UE or network entity as described herein. For example, the operations of the method 1300 may be performed by a UE 115 or a network entity 105 as described with reference to FIGS. 1 through 9. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include receiving at least a portion of a wideband signal for channel estimation of a channel, the wideband signal associated with a first wireless device and based on an FMCW. The operations of block 1305 may be performed in accordance with examples as disclosed herein. In some examples, aspects of the operations of 1305 may be performed by a wideband signal receiving component 740 as described with reference to FIG. 7. In some cases, means for performing the operations of 1305 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1305 at a network entity 105 may include, for example, one or more antennas 915, a transceiver 910, a communications manager 920, one or more memories 925 (e.g., including code 930), one or more processors 935, one or more buses 940, or any combination thereof.

At 1310, the method may include de-scrambling the portion of the wideband signal using an FD scrambling sequence corresponding to the first wireless device. The operations of block 1310 may be performed in accordance with examples as disclosed herein. In some examples, aspects of the operations of 1310 may be performed by an FD de-scrambling component 745 as described with reference to FIG. 7. In some cases, means for performing the operations of 1310 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1310 at a network entity 105 may include, for example, one or more antennas 915, a transceiver 910, a communications manager 920, one or more memories 925 (e.g., including code 930), one or more processors 935, one or more buses 940, or any combination thereof.

At 1315, the method may include communicating signaling via the channel according to the channel estimation of the channel based on the de-scrambled portion of the wideband signal. The operations of block 1315 may be performed in accordance with examples as disclosed herein. In some examples, aspects of the operations of 1315 may be performed by a channel signaling component 750 as described with reference to FIG. 7. In some cases, means for performing the operations of 1315 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1315 at a network entity 105 may include, for example, one or more antennas 915, a transceiver 910, a communications manager 920, one or more memories 925 (e.g., including code 930), one or more processors 935, one or more buses 940, or any combination thereof.

At 1320, the method may include determining an ID of the first wireless device associated with the wideband signal based on de-scrambling the portion of the wideband signal using the FD scrambling sequence. The operations of block 1320 may be performed in accordance with examples as disclosed herein. In some examples, aspects of the operations of 1320 may be performed by an identifier component 770 as described with reference to FIG. 7. In some cases, means for performing the operations of 1320 at a UE 115 may include, for example, one or more antennas 825, a transceiver 815, a communications manager 820, one or more memories 830 (e.g., including code 835), one or more processors 840, one or more buses 845, or any combination thereof. Additionally, or alternatively, means for performing the operations of 1320 at a network entity 105 may include, for example, one or more antennas 915, a transceiver 910, a communications manager 920, one or more memories 925 (e.g., including code 930), one or more processors 935, one or more buses 940, or any combination thereof.

The following provides an overview of aspects of the present disclosure:

Aspect 1: A method for wireless communications at a first wireless device, comprising: generating an FD representation of a reference signal based at least in part on a DFT of an FMCW; scrambling the FD representation of the reference signal using an FD scrambling sequence corresponding to the first wireless device; and transmitting a wideband signal for channel estimation of a channel at a second wireless device based at least in part on the scrambled FD representation of the reference signal.

Aspect 2: The method of aspect 1, further comprising: communicating signaling via the channel according to the channel estimation of the channel based at least in part on the scrambled FD representation of the reference signal.

Aspect 3: The method of either of aspects 1 or 2, further comprising: transmitting configuration signaling indicating the FD scrambling sequence corresponding to the first wireless device.

Aspect 4: The method of aspect 3, wherein the configuration signaling comprises an RRC signal, a MAC-CE signal, a DCI signal, or any combination thereof.

Aspect 5: The method of either of aspects 1 or 2, further comprising: transmitting an indication to determine the FD scrambling sequence based at least in part on a cell ID associated with the first wireless device, a UE ID associated with the first wireless device, or any combination thereof.

Aspect 6: The method of any of aspects 1 through 5, wherein a length of the FD scrambling sequence is based at least in part on a capability of the second wireless device.

Aspect 7: The method of aspect 6, wherein the capability of the second wireless device is based at least in part on a baseband bandwidth processing capability, an analog receiving capability, a digital receiving capability, or any combination thereof of the second wireless device.

Aspect 8: The method of any of aspects 1 through 7, wherein scrambling the FD representation of the reference signal comprises: scrambling a plurality of sets of contiguous frequency resources of the FD representation of the reference signal based at least in part on a length of the FD scrambling sequence, wherein a set of contiguous frequency resources within the plurality of sets of contiguous frequency resources is scrambled using a respective bit of the FD scrambling sequence.

Aspect 9: The method of any of aspects 1 through 8, wherein transmitting the wideband signal comprises: transmitting the wideband signal via a digital transceiver or an analog transceiver.

Aspect 10: The method of any of aspects 1 through 9, further comprising: determining the FD scrambling sequence based at least in part on a digital modulation scheme of the first wireless device, a cell ID associated with the first wireless device, a UE ID associated with the first wireless device, or any combination thereof.

Aspect 11: A method for wireless communications at a second wireless device, comprising: receiving at least a portion of a wideband signal for channel estimation of a channel, the wideband signal associated with a first wireless device and based at least in part on an FMCW; de-scrambling the portion of the wideband signal using an FD scrambling sequence corresponding to the first wireless device; and communicating signaling via the channel according to the channel estimation of the channel based at least in part on the de-scrambled portion of the wideband signal.

Aspect 12: The method of aspect 11, further comprising: determining an ID of the first wireless device associated with the wideband signal based at least in part on de-scrambling the portion of the wideband signal using the FD scrambling sequence.

Aspect 13: The method of aspect 12, further comprising: performing interference cancelation of additional signaling associated with a third wireless device based at least in part on the ID of the first wireless device associated with the wideband signal.

Aspect 14: The method of any of aspects 11 through 13, further comprising: receiving configuration signaling indicating the FD scrambling sequence.

Aspect 15: The method of aspect 14, wherein the configuration signaling comprises an RRC signal, a MAC-CE signal, a DCI signal, or any combination thereof.

Aspect 16: The method of any of aspects 11 through 13, further comprising: receiving an indication to determine the FD scrambling sequence based at least in part on a cell ID associated with the first wireless device, a UE ID associated with the first wireless device, or any combination thereof; and determining the FD scrambling sequence based at least in part on the indication.

Aspect 17: The method of any of aspects 11 through 16, wherein a length of the FD scrambling sequence is based at least in part on a capability of the second wireless device.

Aspect 18: The method of aspect 17, wherein the capability of the second wireless device is based at least in part on a baseband bandwidth processing capability, an analog receiving capability, a digital receiving capability, or any combination thereof of the second wireless device.

Aspect 19: The method of any of aspects 11 through 18, wherein de-scrambling the portion of the wideband signal comprises: de-scrambling a plurality of sets of contiguous frequency resources corresponding to the portion of the wideband signal based at least in part on a length of the FD scrambling sequence, wherein a set of contiguous frequency resources within the plurality of sets of contiguous frequency resources is de-scrambled using a respective bit of the FD scrambling sequence.

Aspect 20: The method of any of aspects 11 through 19, wherein receiving at least the portion of the wideband signal comprises: receiving at least the portion of the wideband signal via a digital transceiver or an analog transceiver.

Aspect 21: The method of any of aspects 11 through 20, wherein de-scrambling the portion of the wideband signal comprises: generating a local FMCW; and de-scrambling the portion of the wideband signal based at least in part on combining the local FMCW with the FMCW corresponding to the wideband signal.

Aspect 22: A first wireless device, comprising: one or more memories storing processor-executable code; and one or more processors coupled with the one or more memories and individually or collectively operable to execute the code to cause the first wireless device to perform a method of any of aspects 1 through 10.

Aspect 23: An apparatus of a first wireless device for wireless communications, comprising at least one means for performing a method of any of aspects 1 through 10.

Aspect 24: A non-transitory computer-readable medium storing code for wireless communications, the code comprising instructions executable by one or more processors to perform a method of any of aspects 1 through 10.

Aspect 25: A second wireless device, comprising: one or more memories storing processor-executable code; and one or more processors coupled with the one or more memories and individually or collectively operable to execute the code to cause the second wireless device to perform a method of any of aspects 11 through 21.

Aspect 26: An apparatus of a second wireless device for wireless communications, comprising at least one means for performing a method of any of aspects 11 through 21.

Aspect 27: A non-transitory computer-readable medium storing code for wireless communications, the code comprising instructions executable by one or more processors to perform a method of any of aspects 11 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
generate a frequency-domain representation of a reference signal based at least in part on a discrete Fourier transform of a frequency modulated continuous waveform;
scramble the frequency-domain representation of the reference signal using a frequency-domain scrambling sequence corresponding to the first wireless device; and
transmit a wideband signal for channel estimation of a channel at a second wireless device based at least in part on the scrambled frequency-domain representation of the reference signal.

2. The first wireless device of claim 1, wherein the one or more processors are individually or collectively further operable to execute the code to cause the first wireless device to:
communicate signaling via the channel according to the channel estimation of the channel based at least in part on the scrambled frequency-domain representation of the reference signal.

3. The first wireless device of claim 1, wherein the one or more processors are individually or collectively further operable to execute the code to cause the first wireless device to:
transmit configuration signaling indicating the frequency-domain scrambling sequence corresponding to the first wireless device.

4. The first wireless device of claim 3, wherein the configuration signaling comprises a radio resource control signal, a medium access control-control element signal, a downlink control information signal, or any combination thereof.

5. The first wireless device of claim 1, wherein the one or more processors are individually or collectively further operable to execute the code to cause the first wireless device to:
transmit an indication to determine the frequency-domain scrambling sequence based at least in part on a cell identifier associated with the first wireless device, a user equipment (UE) identifier associated with the first wireless device, or any combination thereof.

6. The first wireless device of claim 1, wherein a length of the frequency-domain scrambling sequence is based at least in part on a capability of the second wireless device.

7. The first wireless device of claim 6, wherein the capability of the second wireless device is based at least in part on a baseband bandwidth processing capability, an analog receiving capability, a digital receiving capability, or any combination thereof of the second wireless device.

8. The first wireless device of claim 1, wherein, to scramble the frequency-domain representation of the reference signal, the one or more processors are individually or collectively operable to execute the code to cause the first wireless device to:
scramble a plurality of sets of contiguous frequency resources of the frequency-domain representation of the reference signal based at least in part on a length of the frequency-domain scrambling sequence, wherein a set of contiguous frequency resources within the plurality of sets of contiguous frequency resources is scrambled using a respective bit of the frequency-domain scrambling sequence.

9. The first wireless device of claim 1, wherein, to transmit the wideband signal, the one or more processors are individually or collectively operable to execute the code to cause the first wireless device to:
transmit the wideband signal via a digital transceiver or an analog transceiver.

10. The first wireless device of claim 1, wherein the one or more processors are individually or collectively further operable to execute the code to cause the first wireless device to:
determine the frequency-domain scrambling sequence based at least in part on a digital modulation scheme of the first wireless device, a cell identifier associated with the first wireless device, a user equipment (UE) identifier associated with the first wireless device, or any combination thereof.

11. A second wireless device, comprising:
one or more memories storing processor-executable code; and
one or more processors coupled with the one or more memories and individually or collectively operable to execute the code to cause the second wireless device to:
receive at least a portion of a wideband signal for channel estimation of a channel, the wideband signal associated with a first wireless device and based at least in part on a frequency modulated continuous waveform;
de-scramble the portion of the wideband signal using a frequency-domain scrambling sequence corresponding to the first wireless device; and
communicate signaling via the channel according to the channel estimation of the channel based at least in part on the de-scrambled portion of the wideband signal.

12. The second wireless device of claim 11, wherein the one or more processors are individually or collectively further operable to execute the code to cause the second wireless device to:
determine an identifier of the first wireless device associated with the wideband signal based at least in part on de-scrambling the portion of the wideband signal using the frequency-domain scrambling sequence.

13. The second wireless device of claim 12, wherein the one or more processors are individually or collectively further operable to execute the code to cause the second wireless device to:
perform interference cancelation of additional signaling associated with a third wireless device based at least in part on the identifier of the first wireless device associated with the wideband signal.

14. The second wireless device of claim 11, wherein the one or more processors are individually or collectively further operable to execute the code to cause the second wireless device to:
receive configuration signaling indicating the frequency-domain scrambling sequence.

15. The second wireless device of claim 14, wherein the configuration signaling comprises a radio resource control signal, a medium access control-control element signal, a downlink control information signal, or any combination thereof.

16. The second wireless device of claim 11, wherein the one or more processors are individually or collectively further operable to execute the code to cause the second wireless device to:
receive an indication to determine the frequency-domain scrambling sequence based at least in part on a cell identifier associated with the first wireless device, a user equipment (UE) identifier associated with the first wireless device, or any combination thereof; and
determine the frequency-domain scrambling sequence based at least in part on the indication.

17. The second wireless device of claim 11, wherein a length of the frequency-domain scrambling sequence is based at least in part on a capability of the second wireless device.

18. The second wireless device of claim 17, wherein the capability of the second wireless device is based at least in part on a baseband bandwidth processing capability, an analog receiving capability, a digital receiving capability, or any combination thereof of the second wireless device.

19. The second wireless device of claim 11, wherein, to de-scramble the portion of the wideband signal, the one or more processors are individually or collectively operable to execute the code to cause the second wireless device to:
de-scramble a plurality of sets of contiguous frequency resources corresponding to the portion of the wideband signal based at least in part on a length of the frequency-domain scrambling sequence, wherein a set of contiguous frequency resources within the plurality of sets of contiguous frequency resources is de-scrambled using a respective bit of the frequency-domain scrambling sequence.

20. The second wireless device of claim 11, wherein, to receive at least the portion of the wideband signal, the one or more processors are individually or collectively operable to execute the code to cause the second wireless device to:
receive at least the portion of the wideband signal via a digital transceiver or an analog transceiver.

21. The second wireless device of claim 11, wherein, to de-scramble the portion of the wideband signal, the one or more processors are individually or collectively operable to execute the code to cause the second wireless device to:
generate a local frequency modulated continuous waveform; and
de-scramble the portion of the wideband signal based at least in part on combining the local frequency modulated continuous waveform with the frequency modulated continuous waveform corresponding to the wideband signal.

22. A method for wireless communications at a first wireless device, comprising:
generating a frequency-domain representation of a reference signal based at least in part on a discrete Fourier transform of a frequency modulated continuous waveform;
scrambling the frequency-domain representation of the reference signal using a frequency-domain scrambling sequence corresponding to the first wireless device; and
transmitting a wideband signal for channel estimation of a channel at a second wireless device based at least in part on the scrambled frequency-domain representation of the reference signal.

23. The method of claim 22, further comprising:
transmitting configuration signaling indicating the frequency-domain scrambling sequence corresponding to the first wireless device.

24. The method of claim 22, further comprising:
transmitting an indication to determine the frequency-domain scrambling sequence based at least in part on a cell identifier associated with the first wireless device, a user equipment (UE) identifier associated with the first wireless device, or any combination thereof.

25. The method of claim 22, wherein scrambling the frequency-domain representation of the reference signal comprises:
scrambling a plurality of sets of contiguous frequency resources of the frequency-domain representation of the reference signal based at least in part on a length of the frequency-domain scrambling sequence, wherein a set of contiguous frequency resources within the plurality of sets of contiguous frequency resources is scrambled using a respective bit of the frequency-domain scrambling sequence.

26. The method of claim 22, further comprising:
determining the frequency-domain scrambling sequence based at least in part on a digital modulation scheme of the first wireless device, a cell identifier associated with the first wireless device, a user equipment (UE) identifier associated with the first wireless device, or any combination thereof.

27. A method for wireless communications at a second wireless device, comprising:
receiving at least a portion of a wideband signal for channel estimation of a channel, the wideband signal associated with a first wireless device and based at least in part on a frequency modulated continuous waveform;
de-scrambling the portion of the wideband signal using a frequency-domain scrambling sequence corresponding to the first wireless device; and
communicating signaling via the channel according to the channel estimation of the channel based at least in part on the de-scrambled portion of the wideband signal.

28. The method of claim 27, further comprising:
determining an identifier of the first wireless device associated with the wideband signal based at least in part on de-scrambling the portion of the wideband signal using the frequency-domain scrambling sequence.

29. The method of claim 27, further comprising:
receiving an indication to determine the frequency-domain scrambling sequence based at least in part on a cell identifier associated with the first wireless device, a user equipment (UE) identifier associated with the first wireless device, or any combination thereof; and
determining the frequency-domain scrambling sequence based at least in part on the indication.

30. The method of claim 27, wherein de-scrambling the portion of the wideband signal comprises:
de-scrambling a plurality of sets of contiguous frequency resources corresponding to the portion of the wideband signal based at least in part on a length of the frequency-domain scrambling sequence, wherein a set of contiguous frequency resources within the plurality of sets of contiguous frequency resources is de-scrambled using a respective bit of the frequency-domain scrambling sequence.
